(19) United States
(12) Patent Application Publication
(10) Pub. No.: US 2026/0094294 A1
(43) Pub. Date: Apr. 2, 2026

(54) SYSTEM AND METHOD FOR ANALYZING A MULTIDIMENSIONAL SURFACE

(71) Applicant: APPLICATIONS MOBILES OVERVIEW INC., Montreal (CA)

(72) Inventors: Ghislain LAPERLE, Sherbrooke (CA); Alireza JAVAHERI, Kingston (CA); Laurent JUPPE, Montreal (CA); Sherif Omar ABUELWAFA, Verdun (CA); Yann MAJEWSKI, Montreal (CA); Alvaro DIAZ, Montreal (CA); Marie-Eve DESROCHERS, Montreal (CA); Olha SEREDA, Montreal (CA)

(21) Appl. No.: 19/346,387

(22) Filed: Sep. 30, 2025

Related U.S. Application Data
(60) Provisional application No. 63/702,361, filed on Oct. 2, 2024.

(51) Int. Cl. G06T 7/70; G01B 11/00; G01B 11/30

(52) U.S. Cl. CPC G06T 7/70; G01B 11/005; G01B 11/303; G06T 2207/10028; G06T 2207/30248

(57) ABSTRACT

Methods of and systems for analyzing a multidimensional surface are disclosed. A parametric 3D surface of an object of interest is calculated for a surface of the object of interest defined in a 3D point cloud. A sufficiency of the parametric 3D surface is determined by evaluating a distance between the parametric 3D surface and the surface of the object of interest defined in the 3D point cloud. If the parametrical 3D surface is determined not to be sufficient, the parameters of the parametric 3D surface are modified, and the parametric 3D surface is calculated again. If the parametric 3D surface is determined to be sufficient, the parametric 3D surface is positioned on the surface of the object of interest defined in the 3D point cloud and some 3D data points of the object of interest are removed if they are above a certain distance from the parametric 3D surface.

### CROSS-REFERENCE

The present application claims the benefit of, and priority to, U.S. Provisional Patent Application No. 63/702,361, filed Oct. 2, 2024, and entitled “SYSTEM AND METHOD FOR ANALYZING A MULTIDIMENSIONAL SURFACE”, the entirety of which is incorporated herein by reference.

### FIELD

The present technology relates to non-destructive testing systems and methods. In particular, a system and a method for analyzing a multidimensional surface are introduced.

### BACKGROUND

Three-dimensional (3D) digital data may be produced by a variety of devices that involve 3D scanning or sampling and/or numerical modeling. In one example, 3D laser scanners generate 3D digital data. A long-range laser scanner is fixed in one location and rotated to scan objects around it. Alternatively, a short-range laser scanner is mounted on a device that moves around an object while scanning it. 3D cameras capturing ordinary (non-laser light) may also be used.

Other examples of ways to generate 3D digital data are by using depth cameras or 3D scanners to generate 3D digital data by collecting a complete point set of (x, y, z) locations that represent the shape of an object. 3D digital imaging data may also be generated by combining data points from multiple images acquired using two-dimensional (2D) cameras, including ordinary digital cameras, high precision cameras, or even cameras incorporated in a mobile phone.

Once collected, these point sets, also known as 3D point clouds, are sent to an image rendering system, which then processes the point data to generate a 3D representation of the object. In any of the scenarios, the location of each point scanned is represented as a polar coordinate since the angle between the scanner and the object and distance from the scanner to the object are known. The polar coordinates are then converted to 3D Cartesian coordinates and stored in the form of a point cloud along with a corresponding intensity or color value for the data point collected by the scanner.

Currently existing non destructive imaging techniques generally require using complex and expensive tools used by highly skilled technicians. Even though the recent developments identified above may provide benefits, improvements are still desirable.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

### SUMMARY

It is an object of the present technology to ameliorate at least some of the inconveniences present in the prior art.

Analysis of the 3D point clouds generated from techniques such as the ones mentioned above are usually reserved to skilled persons. The systems and methods described herein may allow non-specialist users to automatically analyze 3D digital twins of real objects without any prior knowledge in the field of the scanned objects. This analysis may include weariness, roughness, irregularity, surface quality, automatic characteristics and/or measures in fields such as industrial parts, welding, rails, body parts.

According to a first broad aspect of the present technology, there is provided a method for analyzing a body part, comprising: obtaining a three-dimensional (3D) point cloud of the body part; determining, based on the 3D point cloud, a first parametric surface corresponding to a surface of the body part; determining a first measure of distance between the first parametric surface and the surface of the body part in the 3D point cloud; after determining that the first measure of distance fails to satisfy a threshold measure of distance, removing, from the 3D point cloud, data points that are greater than a predetermined distance from the first parametric surface; determining, based on the 3D point cloud after removing the data points greater than the predetermined distance from the first parametric surface, a second parametric surface corresponding to the surface of the body part determining a second measure of distance between the second parametric surface and the surface of the body part in the 3D point cloud; and after determining that the second measure of distance satisfies the threshold measure of distance, positioning the second parametric surface on the surface of the body part defined in the initial 3D point cloud to form a final 3D point cloud.

In some implementations of the method, the method further comprises determining, based on the second parametric surface, a measurement of the body part.

In some implementations of the method, the iterations of parametric surfaces continues above two until the measure of distances satisfies the threshold measure of distance after removing the data points greater than the predetermined distance from the current parametric surface.

In some implementations of the method, the final iterated parametric surface is positioned on an intermediate state obtained during iterations of the object of interest instead of on the initial state.

In some implementations of the method, the parametric surface is a polynomial surface of degree D, D being defined to minimize the distance between the current polynomial surface and the current 3D point cloud.

In some implementations of the method, the parametric surface is a spline that is determined by minimizing the distance between the current spline and the current 3D point cloud.

According to another broad aspect of the present technology, there is provided a method for analyzing a multidimensional surface, comprising: obtaining a three-dimensional (3D) point cloud of an object of interest, wherein the object of interest is not a vehicle tire or a vehicle track; determining, based on the 3D point cloud, a first parametric surface corresponding to a surface of the object of interest; determining a first measure of distance between the first parametric surface and the surface of the object of interest in the 3D point cloud; after determining that the first measure of distance fails to satisfy a threshold measure of distance, removing, from the 3D point cloud, data points that are greater than a predetermined distance from the first parametric surface; determining, based on the 3D point cloud after removing the data points greater than the predetermined distance from the first parametric surface, a second parametric surface corresponding to the surface of the object of interest; determining a second measure of distance between the second parametric surface and the surface of the object of interest in the 3D point cloud; and after determining that the second measure of distance satisfies the threshold measure of distance, positioning the second parametric surface on the surface of the object of interest defined in the 3D point cloud to form a final 3D point cloud.

In some implementations of the method, the method further comprises determining, based on the second parametric surface, a measure of wear of the object of interest.

In some implementations of the method, the method further comprises determining, based on the second parametric surface, a measure of irregularity of the object of interest.

In some implementations of the method, the method further comprises performing subsequent analysis on the second parametric surface.

In some implementations of the method, the iterations of parametric surfaces continues above two until the measure of distances satisfies the threshold measure of distance after removing the data points greater than the predetermined distance from the current parametric surface.

In some implementations of the method, the final iterated parametric surface is positioned on an intermediate state obtained during iterations of the object of interest instead of on the initial state.

In some implementations of the method, the parametric surface is a polynomial surface of degree D, D being defined to minimize the distance between the current polynomial surface and the current 3D point cloud.

In some implementations of the method, the parametric surface is a spline that is determined by minimizing the distance between the current spline and the current 3D point cloud.

According to another broad aspect of the present technology, there is provided a method for analyzing a multidimensional surface, comprising: a) obtaining a three-dimensional (3D) point cloud of an object of interest; b) initializing a value D for a degree of a polynomial surface to be calculated; c) calculating a D-degree polynomial surface of the object of interest, the D-degree polynomial surface being calculated for a surface of the object of interest defined in the 3D point cloud; d) determining a sufficiency of the D-degree polynomial surface by evaluating a distance between the D-degree polynomial surface and the surface of the object of interest defined in the 3D point cloud; e) in response to the D-degree polynomial surface being determined not to be sufficient, selectively increasing the degree D and returning to c); f) in response to the D-degree polynomial surface being determined to be sufficient: g) selectively positioning the D-degree polynomial surface on the surface of the object of interest defined in the 3D point cloud to form a final 3D point cloud.

In some implementations of the method, the degree D is initialized to 1 in operation b).

In some implementations of the method, evaluating the distance between the D-degree polynomial surface and the surface of the object of interest defined in the 3D point cloud comprises comparing the distance to a predetermined threshold.

In some implementations of the method, the method further comprises counting a number of occurrences of operation c) and continuing at operation g) regardless of the sufficiency of the D-degree polynomial surface if the number of occurrences of operation c) meets or exceeds a predetermined threshold.

In some implementations of the method, the method further comprises evaluating a compliance of the final 3D point cloud to a specification for the object of interest.

In some implementations of the method, evaluating the compliance of the final 3D point cloud comprises evaluating a distance of image data points of the final 3D point cloud with image data points of the specification for the object of interest.

In some implementations of the method, evaluating the compliance of the final 3D point cloud comprises evaluating a compliance of the object of interest to manufacturing tolerances.

In some implementations of the method, evaluating the compliance of the final 3D point cloud comprises evaluating a level of wear of the object of interest.

In some implementations of the method, evaluating the compliance of the final 3D point cloud comprises evaluating a remaining lifetime of the object of interest.

In some implementations of the method, the surface of the object of interest defined in the 3D point cloud is one of a top surface, a bottom surface, or a middle of the object of interest defined in the 3D point cloud.

In some implementations of the method, the method further comprises before operation c), initializing to 1 a counter i for a number of image data point discarding operations; and after f) and before g): h) calculating a ratio Ri of (i) image data points of the 3D point cloud of the object of interest that are on one side of the D-degree polynomial surface over (ii) image data points of the 3D point cloud of the object of interest that are on the other side the D-degree polynomial surface, i) forming a new 3D point cloud by discarding at least some of the image data points of the 3D point cloud of the object of interest that are on one side of the D-degree polynomial surface, and j) determining a sufficiency of the D-degree polynomial surface by evaluating a distance between the D-degree polynomial surface and the object of interest defined in the new 3D point cloud.

In some implementations of the method, discarding at least some of the image data points of the 3D point cloud comprises one of (i) discarding all of the image data points of the 3D point cloud of the object of interest that are on one side of the D-Degree polynomial surface, (ii) discarding a predetermined fraction of the image data points of the 3D point cloud of the object of interest that are on one side of the D-Degree polynomial surface, and (iii) discarding a fraction of the image data points of the 3D point cloud of the object of interest that are on one side of the D-Degree polynomial surface, the fraction being determined as a function of Ri.

In some implementations of the method, evaluating the distance between the D-degree polynomial surface and the object of interest defined in the new 3D point cloud comprises forming a histogram of distances between image data points in the D-degree polynomial surface and image data points of the object of interest defined in the new 3D point cloud.

In some implementations of the method, the method further comprises in response to the D-degree polynomial surface being determined to be sufficient in j): continuing at g); and in response to the D-degree polynomial surface being determined not to be sufficient: incrementing or decrementing the value of D by at least 1, incrementing the value of N by 1, and returning to c).

In some implementations of the method, the ratio Ri is defined by (i) image data points of the 3D point cloud of the object of interest that are over a distance from the D-degree polynomial surface and should be discarded divided by (ii) image data points of the 3D point cloud of the object of interest that are under the distance from the D-degree polynomial surface and should be kept.

In some implementations of the method, the distance from the D-degree polynomial surface is determined based on the characteristics to analyze on the object of interest and/or a percentage of the maximum distance between the object of interest and the D-Degree polynomial surface.

In some implementations of the method, the D-degree polynomial surface is a parametric surface which is initialized, adjusted and evaluated in relation with the 3D object of interest by iteratively modifying the parameters defining the parametric surface.

According to another broad aspect of the present technology, there is provided a system for analyzing a multidimensional surface, comprising: a camera configured to provide a three-dimensional (3D) point cloud of an object of interest; a computer operatively connected to the camera; and a non-transitory computer-readable medium storing computer-readable instructions that, upon being executed by the computer, cause the system to perform any of the methods described above.

The proposed method applies to objects for which a characteristic part to analyze can relate to a known mathematical reference object such as a parametric object or an average object obtained by regression/average/interpolation methods to be fitted on the 3D object to analyze. Each 3D point of the 3D object to analyze will have a distance to the reference 3D object, and each of these distances will be plotted in a distance distribution graph for subsequent analysis.

As part of the method, an iteration of the 3D reference object may be performed based on instructions from a skilled person in the field of the object to be analyzed. As a non-limitative example, the weariness of a gear should be considered at the top of its teeth, thus the reference of the surface (in this case a cylinder or a polynomial surface) should be fitted with the bottom of the gear's teeth, i.e. the base circle of the gear. In another example, the irregularities of a rail should be analyzed in relation to a perfect planar surface on its top, and a super ellipsoid will be iteratively fitted on its top. In another example, a body part circumference measure (i.e. chest circumference) should be considered relative to a spline obtained through well-known regression or interpolation methods and iteratively positioned in the middle of the body slice to analyze.

As another part of the method, the 3D reference object being a parametric object, a sub-iteration is performed on the parameters at each step of the fitting iteration in order to find the best fitted 3D parametric object at each step of the fitting iteration. The method thus comprises two levels of iteration: i) a main iteration process to fit a 3D parametric object at the researched position on the 3D object of interest, and ii) a sub-iteration process to find the best parameters for the 3D parametric surface at each step of the main iteration.

Once the reference mathematical object has been iteratively positioned to represent the reference of analysis to make, it is merged with the original object to plot the distances of each 3D point of the original object to the fitted mathematical object and conduct subsequent analysis from this distribution. Alternatively, the iteratively positioned 3D reference surface can be merged with an intermediate representation of the original 3D object of interest at any step of the iteration instead of the original representation of the 3D point cloud.

In the following description, “3D reference surface” will refer to any mathematical spline or surface defined by parameters which definition is well known by the skilled person such as, but not limited to splines or surfaces obtained by interpolation and/or regression, planes, spheres, elliptic paraboloids, cylinders, cones, polynomial surfaces supershapes, parametric surfaces, alpha shapes, convex hulls, concave hulls, etc. To simplify the description of the invention, polynomial surfaces examples are used which are easily described by their degrees D but it should be understood that the examples can be extrapolated to parametric surfaces described by a more extended set of parameters.

It is to be noted that a different type of 3D parametric reference surface can be fitted at each step of the main iteration, its specific parameters being determined by sub-iterations.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIGS. 1a, 1b, 1c, 1d, 1e, 1f, and 1g illustrate a numerical technique for defining a polynomial surface fitting on an object in accordance with an embodiment of the present technology;

FIG. 2 is a flowchart of a method for analysing a multidimensional surface in accordance with an embodiment of the present technology;

FIGS. 3a and 3b show histograms of data points as a function of their distance to a polynomial surface in accordance with an embodiment of the present technology;

FIG. 4 illustrates a system for analysing a multidimensional surface in accordance with an embodiment of the present technology;

FIG. 5 is a block diagram of a computer in accordance with an embodiment of the present technology;

FIG. 6 is a histogram of cloud to mesh (C2M) signed distances used to evaluate an intermediate or final result of the method for analysing a multidimensional surface in accordance with an embodiment of the present technology. In most embodiments, the point cloud will be the 3D object to analyze and the mesh will be the reference surface;

FIG. 7 is a histogram of a final measure in accordance with an embodiment of the present technology;

FIG. 8 is a 3D point cloud showing a computed-aided design (CAD) perspective view of a gear;

FIG. 9 is a 3D point cloud showing extracted gear teeth of the gear of FIG. 8;

FIG. 10 is a 3D point cloud of the extracted gears of FIG. 9 after a first polynomial fit iteration in accordance with an embodiment of the present technology;

FIG. 11 is a histogram of gear depths obtained from the 3D point cloud of FIG. 10;

FIG. 12 is a 3D point cloud of the extracted gears of FIG. 9 after a second polynomial fit iteration in accordance with an embodiment of the present technology;

FIG. 13 is a histogram of gear depths obtained from the 3D point cloud of FIG. 12;

FIG. 14 is a 3D point cloud of the extracted gears of FIG. 9 after a third polynomial fit iteration in accordance with an embodiment of the present technology;

FIG. 15 is a histogram of gear depths obtained from the 3D point cloud of FIG. 14;

FIG. 16 is a 3D point cloud of the extracted gears of FIG. 9 after a fourth and last polynomial fit iteration in accordance with an embodiment of the present technology;

FIG. 17 is a histogram of gear depths obtained from the 3D point cloud of FIG. 16 and the desired measure of the teeth depth measure obtained after a fourth and last iteration;

FIG. 18 is a 3D reconstruction of a welding area and the corresponding 3D point cloud.

FIG. 19 is a 3D point cloud of the extracted welding area of FIG. 18 after a first polynomial fit iteration in accordance with an embodiment of the present technology;

FIG. 20 is a histogram of the welding area obtained from the 3D point cloud of FIG. 19;

FIG. 21 is a 3D point cloud of the extracted welding area of FIG. 18 after a second polynomial fit iteration in accordance with an embodiment of the present technology;

FIG. 22 is a histogram of the welding area obtained from the 3D point cloud of FIG. 21;

FIG. 23 is a 3D point cloud of the extracted welding area of FIG. 18 after a third polynomial fit iteration in accordance with an embodiment of the present technology;

FIG. 24 is a histogram of the welding area obtained from the 3D point cloud of FIG. 23;

FIG. 25 is a 3D point cloud of the extracted welding area of FIG. 18 after a fourth polynomial fit iteration in accordance with an embodiment of the present technology;

FIG. 26 is a histogram of the welding area obtained from the 3D point cloud of FIG. 25;

FIG. 27 is a 3D point cloud of the extracted welding area of FIG. 18 after a fifth and final polynomial fit iteration in accordance with an embodiment of the present technology;

FIG. 28 is a histogram of the welding area obtained from the 3D point cloud of FIG. 27 and the desired measure of the analysis of welding quality after a fifth and last iteration;

FIG. 29 is a 3D reconstruction of a rail and the corresponding 3D point cloud of the area of interest.

FIG. 30 is a 3D point cloud of the rail area of interest of FIG. 29 after a first polynomial fit iteration in accordance with an embodiment of the present technology;

FIG. 31 is a histogram of the rail area of interest obtained from the 3D point cloud of FIG. 30;

FIG. 32 is a 3D point cloud of the rail area of interest of FIG. 29 after a second polynomial fit iteration in accordance with an embodiment of the present technology;

FIG. 33 is a histogram of the rail area of interest obtained from the 3D point cloud of FIG. 32;

FIG. 34 is a 3D point cloud of the rail area of interest of FIG. 29 after a third and final polynomial fit iteration in accordance with an embodiment of the present technology and the corresponding measure of the analysis of unevenness of the rail;

FIG. 35 is an example of results for two rails of different levels of unevenness;

FIGS. 36, 37, 38, 39, 40, 41, and 42 show an example of 3D surface iterative fitting and points removal to obtain a measure of a human wrist; and

FIGS. 43, 44, 45, 46, 47, 48, 49, and 50 show an example of 3D surface iterative fitting and points removal to obtain the measure of the circumference of a human ankle.

Additional and/or alternative features, aspects, and advantages of implementations of the present technology will become apparent from the following description, the accompanying drawings, and the appended claims. It should also be noted that, unless otherwise explicitly specified herein, the drawings are not to scale.

### DETAILED DESCRIPTION

A point cloud representing an object may be generated by scanning the object. After generated the point cloud, various measurements of the object may be taken using the point cloud. Due to the amount of noise present in a point cloud and/or other inaccuracies in the point cloud, significant inaccuracies may be present in these measurements. Using the methods described herein, the accuracy of the measurements taken from a point cloud may be improved.

In order to take measurements of an object, a polynomial surface may be fitted to the object in the point cloud. The polynomial surface may be refined until a distance between the polynomial surface and the points of the point cloud are below a threshold. Points in the point cloud that are on one side of the polynomial surface may be removed at each iteration. Points in the point cloud that are further than a threshold distance from the polynomial surface may be removed at each iteration. In this manner, a polynomial surface may be generated that is closely aligned to the actual surface of the object.

After generating, optimizing and fitting the polynomial surface in a plurality of iterations, measurements of the object may then be taken in relation with the polynomial surface. Because they are taken from a unique reference spline or surface, these measurements and the subsequent analysis may be more accurate than measurements and the subsequent analysis taken from a point cloud using previously known methods. This increased accuracy of the measurements may allow for uses that were not previously possible, such as quality assurance processes, assessing wear on an object, measuring body parts for apparel sizing or other uses, etc.

Previous processes for performing measurements on a point cloud may have included many tasks that were demanding for a computer processor and used significant processing resources and/or significant amounts of memory, such as various de-noising tasks. Using the current method, de-noising and other processing resource intensive and/or memory resource intensive processes might not need to be performed. Measurements may be performed using less processing resources with the current method. This may improve the functioning of a computer system performing these methods because less resources are being used.

Imaging information may be used to evaluate the quality, compliance and/or wear of complex surfaces. For example, during a quality control process, imaging information may be used to evaluate the compliance of an object having complex surfaces to expected manufacturing tolerances and specifications. Imaging information may also be used to evaluate the wear and tear of devices that have been in service for some time, in view of evaluating their expected remaining lifetime and/or in view of evaluating whether they need to be replaced with new parts. Non-limiting examples of such devices include gears in various gearsets and the like.

In the context of the present specification, unless expressly provided otherwise, a computer system may refer to, but is not limited to, an “electronic device”, an “operation system”, a “system”, a “computer-based system”, a “controller unit”, a “monitoring device”, a “control device” and/or any combination thereof appropriate to the relevant task at hand.

In the context of the present specification, unless expressly provided otherwise, the expression “computer-readable medium” and “memory” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives. Still in the context of the present specification, “a” computer-readable medium and “the” computer-readable medium should not be construed as being the same computer-readable medium. To the contrary, and whenever appropriate, “a” computer-readable medium and “the” computer-readable medium may also be construed as a first computer-readable medium and a second computer-readable medium.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

The examples and conditional language recited herein are principally intended to aid the reader in understanding the principles of the present technology and not to limit its scope to such specifically recited examples and conditions. It will be appreciated that those skilled in the art may devise various arrangements that, although not explicitly described or shown herein, nonetheless embody the principles of the present technology.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes that may be substantially represented in non-transitory computer-readable media and so executed by a computer or processor, whether or not such computer or processor is explicitly shown.

Statements herein such as “above” and “below” relate to specific examples in the drawings and should be interpreted in view of the illustrated examples. For a circular object such as a tire or a gear, any part of the object may become positioned at any point on its circumference, so the terms “above” and “below” should not be understood in the absolute, but as a function of their pose as illustrated in the drawings.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

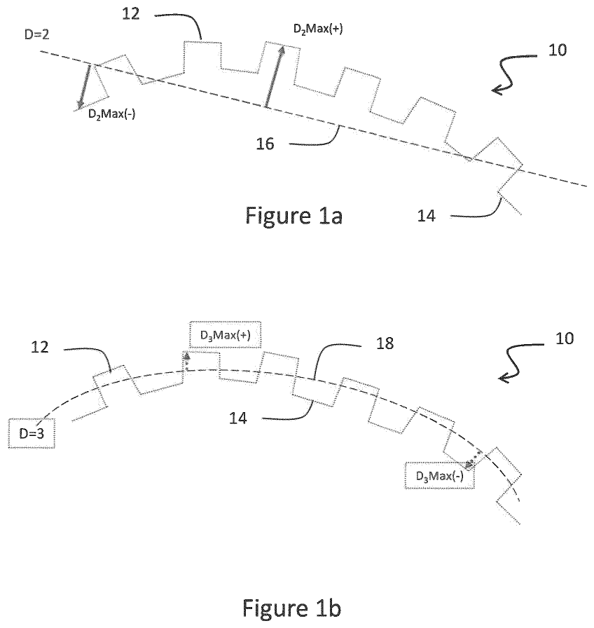

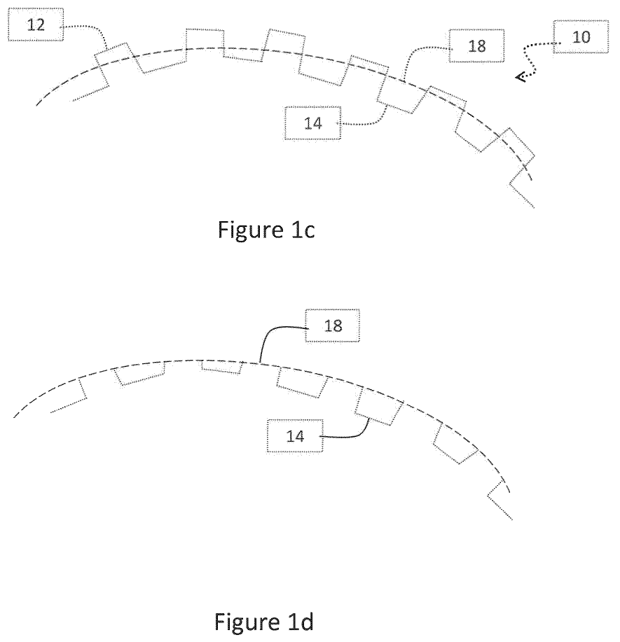

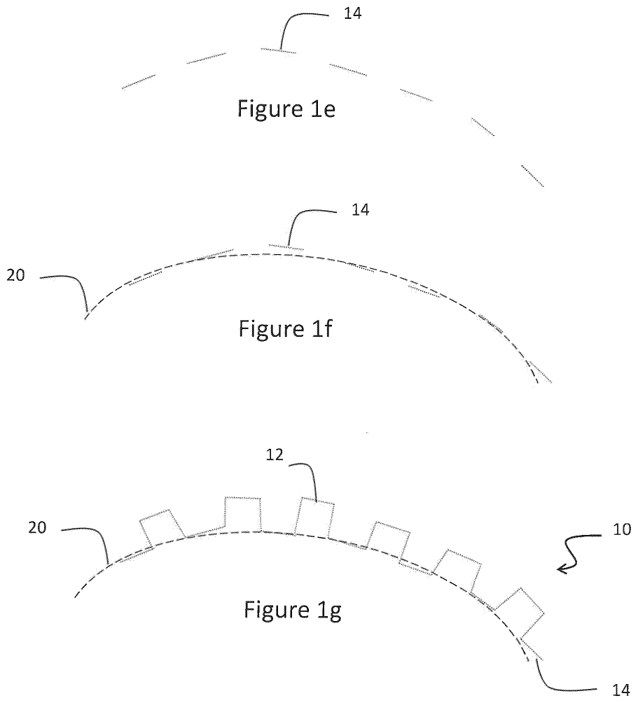

FIGS. 1a to 1g illustrate a numerical technique for defining a polynomial surface fitting on an object (mentioned above as a sub-iteration process). FIG. 1a illustrates a point cloud in which image data points show a section of a gear 10 having a complex surface including peaks 12 and valleys 14. It is desired to track a bottom surface of the gear 10 defined by the bottom of its valleys 14. FIG. 1a illustrates a two-degree (D=2) polynomial surface 16 that tracks (i.e., attempts to track) the bottom surface of the gear 10. As can be seen in FIG. 1A, the polynomial surface 16 is far from properly approximating the actual surface of the gear 10. Distances between the peaks 12 or valleys 14 and the 2-degree polynomial surface 16 range between D₂Max(+), which is a positive value for a peak 12, and D₂Max(−), which is a negative value for a valley 14.

Turning to FIG. 1b, a 3-degree (D=3) polynomial surface 18 provides a much-improved fit on the complex surface of the gear 10. Distances between the peaks 12 or valleys 14 and the 3-degree polynomial surface 18 range between D₃Max(+), which is a positive value for a peak 12, and D₃Max(−), which is a negative value for a valley 14. Remembering that D₂Max(−) and D₃Max(−) are negative values, one can clearly see that:

$${D}_{3} Max ( + ) + {D}_{3} Max ( - ) < {D}_{2} Max ( + ) + {D}_{2} Max ( - ) .$$

The above inequality shows that the 3-degree polynomial surface 18 provides a much better representation of the surface of the gear 10 than the 2-degree polynomial surface 16. It is however possible to improve further the tracking of the surface of the gear 10.

FIG. 1c reproduces the fitting of the D-degree polynomial surface 18 on the gear 10 itself. Then in FIG. 1d, all parts of the gear 10 that are above the D-degree polynomial surface 18 are deleted from the illustration and from further calculations—otherwise stated, in numerical terms, all image data points of the point cloud (the image of the gear) that extend beyond the D-degree polynomial surface 18 are discarded (as an illustration, it could be said that image data points that extend beyond the D-degree polynomial surface 18 are skimmed, or shaved, from the remainder of the point cloud). After one or more additional main iterations of D-degree polynomial fittings (a main iteration including sub-iterations to define the best degree D of a polynomial surface or parameters of any type of 3D parametric surface) as shown in FIG. 1b and/or after discarding additional image data points of the point cloud that extend beyond (in this case above) the D-degree polynomial surface 18 as shown in FIG. 1c, a resulting residual portion 14 of the 3D object of interest 10 will appear as shown on FIG. 1e, representing the bottom/valley 14 of the gear 10. As part as the last iteration of the main iteration process, a final D-degree polynomial surface 20 will be fitted on the valley 14 as shown on FIG. 1f and the obtained D-degree polynomial surface will be applied on the original object of interest, here the gear 10 as shown on FIG. 1g, to fit the surface of the gear 10 as defined by its valleys 14, as shown on FIG. 1g.

FIG. 1g shows that the surface defined by the valleys 14 of the gear 10 is not perfectly tracked by the polynomial surface 20. FIG. 1g is for illustration purposes and represents a non-limiting use case in which there is no requirement for a very precise tracking of the actual surface of the gear 10. This level of precision may suffice for some applications, for example when a roughly designed gear is sufficient for operation in heavy machinery. For other applications, for example for a gear that will be mounted in an aircraft engine, precision of imaging and tracking to the level of one or a few microns may be necessary. The sequence described in relation to FIGS. 1a-1g may thus involve defining a 3-degree, 4-degree, 5-degree polynomial surface, and/or higher degree polynomial surface, with one or more operations for discarding data points as illustrated in FIGS. 1c and 1d. As the degree of the polynomial surface increases and/or the number of iterations increases, the precision of the tracking may improve.

It is to be noted that the non-perfect fitting of the reference polynomial surface in this example may be corrected and/or compensated for by the method of analysing the distances distributions which takes into account points above the surface (positive distances) and the points below the surface (negative distances). The signs of the distances are obtained by using the direction of the normal to the surface as known by the skilled person.

In any case, the tracked image of the surface of the gear 10 may then be compared with specified data for that surface in order to determine whether a manufactured gear complies with expected tolerances (for a new product), or in order to determine whether a used gear should be replaced. An expected remaining lifetime of a used gear may also be evaluated by determining an amount of wear of the gear over time.

The example of FIGS. 1a to 1g describe how the above technique may be used to track and fit the surface of the gear 10 defined by its valleys 14. It would also be possible to use the same technique to track and fit a surface of the gear 10 defined by its peaks 12. Notably, considering FIGS. 1c and 1d, the image data points that represent parts of the gear 10 below the D-degree polynomial surface 18 would be deleted from the illustration and from further calculations. Otherwise stated, in numerical terms, in order to track the peaks 12 of the gear 10, all image data points of the image of the gear 10 that extend under the D-degree polynomial surface 18 would be discarded.

In a more general approach, the part of the point cloud to analyze/measure will define the process of skimming/shaving as defined by the skilled person in the field of the object to measure/analyze.

As examples to illustrate this part of the method, and according to what is to be analyzed or measures, skimming/shaving can be performed above the surface (analyze of the weariness of a gear as presented before), below the surface (analyze of the irregularities of a rail) or on each side if the surface (measure of a circumference of a human body part, analysis of a welding quality . . . ).

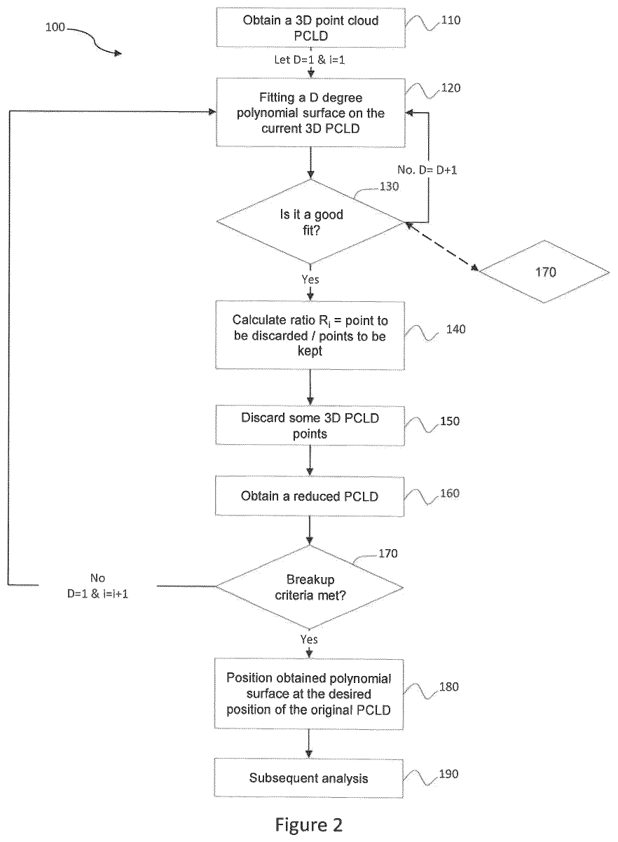

FIG. 2 is a flowchart of a method for analysing a multidimensional surface. On FIG. 2, a sequence 100 comprises a plurality of operations, some of which may be executed in variable order, some of the operations possibly being executed concurrently, some of the operations being optional. In one or more aspects, the sequence 100, or one or more steps thereof may be performed by a computing system. The sequence 100, or one or more steps thereof may be embodied in computer-executable instructions that are stored in a computer-readable medium, such as a non-transitory mass storage device, loaded into memory and executed by a CPU. The sequence 100 is exemplary, and it should be understood that some steps or portions of steps in the flow diagram may be omitted and/or changed in order. It is to be noted that for clarity FIG. 2 is representing a parametric 3D surface which is a D-Degree polynomial surface. The skilled person will understand that D can be understood as an iteration variable and that the flow will remain valid if this sub-iteration is applied on parameters defining a parametric 3D surface.

Some or all of the following operations are executed:

Operation 110: A 3D point cloud of an object of interest is obtained. The object of interest may be any manufactured object, for example a gear, a train track (i.e. a rail), a body part, or any object having a complex surface. It is contemplated that the point cloud could also provide an image of an object that is not man-made, for example a pearl for which there is a desire to evaluate its sphericity. A first value of ‘D’ (degrees for the polynomial surface fitting process, or a set of parameters for any 3D parametric surface as known by the skilled person) is selected, being for example set to 1, 2 or 3, and a number ‘N’ for a number of image data point discarding operations may be initialized to 1.

Operation 120: The polynomial surface to fit on the object of interest is calculated for that value of ‘degrees’, i.e., ‘D’. As known by the skilled person, the general equation for a polynomial surface of degree D is

$$z = {\sum }_{i = 0}^{m} {\sum }_{j = 0}^{n} {a}_{ij} {x}^{i} {y}^{j} ,$$

where D=m+n and aᵢⱼ=0 if i+j>D. As common examples in the implementation of this invention, D is often ranging from 2 to 4. A polynomial surface of degree 2 is defined by z=a₂₀x²+a₀₂y²+a₁₁xy+a₁₀x+a₀₁y+a₀₀ (note that a₁₂=a₂₁=a₂₂=0), a polynomial surface of degree 3 is defined by z=a₃₀x³+a₀₃ y³+a₂₁ x²y+a₁₂ xy²+a₂₀ x²+a₀₂ y²+a₁₁ xy+a₁₀ x+a₀₁ y+a₀₀ (note that a₁₃=a₃₁=a₂₃=a₃₂=a₂₂=a₃₃=0), a polynomial surface of degree 4 is defined by z=a₄₀x⁴+a₀₄y⁴+a₃₁x³y+a₁₃xy³+a₂₂x²y²+a₃₀x³+a₀₃y³+a₂₁x²y+a₁₂xy²+a₂₀x²+a₀₂y²+a₁₁xy+a₁₀x+a₀₁y+a₀₀ (note that a₁₄=a₄₁=a₂₃=a₃₂=a₄₂=a₂₄=a₃₃=a₃₄=a₄₃=a₄₄=0).

Fitting a polynomial surface to a point cloud consists in determining the coefficients aᵢⱼ that will minimize the distance between the polynomial surface and the 3D point cloud to analyze. Several methods to perform this fitting are known by the skilled person, such as least square method, root-finding algorithms, such as iterative methods on the coefficients aᵢⱼ (Newton's method, Secant method, Steffensen's method, fixed point iteration method), bracketing methods (bisection method, false position method, ITP method), interpolation method, regression methods based on least squares estimation and/or a combination of those methods. Although operation 120 describes fitting a polynomial surface to the object of interest, it should be understood that other types of surfaces may be determined for the object of interest, such as a parametric surface as known by the skilled person.

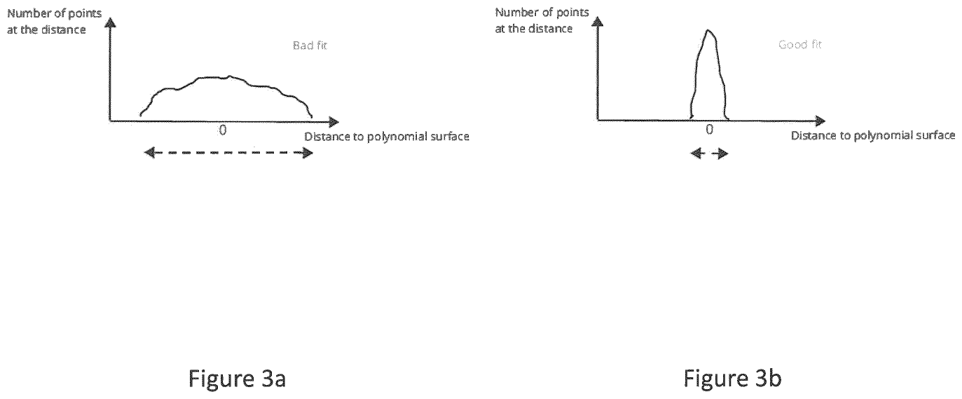

Operation 130: A determination is made of the sufficiency of the fit for the polynomial surface. For example, this determination may be made by evaluating a histogram of distances between the polynomial surface and the surface defined in the original point cloud (or a remaining point cloud obtained from the original point cloud), thresholds on amplitude and/or standard deviation of the distances, and the like. These distances may be calculated, for example and without limitation, as a C2C (cloud to cloud) distance, or as a C2M (cloud to mesh) distance. Turning to FIGS. 3a and 3b, histograms of data points as a function of their distance to the polynomial surface may show a bad fit (FIG. 3a, in which there is a broad distribution of points) or a good fit (FIG. 3b, in which the distribution is narrow). Tolerances used for evaluating the sufficiency of the fit of the polynomial surface may vary according to the application. If the polynomial surface is not considered to be sufficiently fitting for the task at hand, the value of D (the number of degrees) is incremented, and the sequence returns to operation 120 where a polynomial surface having a higher degree is determined. Alternatively, the value of D may be decremented if it is found that a previous incrementing of D has led to a worsening of the fit. A maximum number of iterations between operations 120 and 130 may be predetermined and/or a maximum degree D may be predefined, so that execution is allowed to proceed to the next operations.

Alternatively, the evaluation of operation 130 can be made according to evaluation of operation 170 in such a way that it is evaluated if modifying the degree ‘D’ of a polynomial surface (or parameters of a parametric surface) is giving better results at operation 170 as it will be detailed hereafter.

If the polynomial surface is considered to be sufficiently accurate, the sequence 100 may continue at operation 140 to further refine the polynomial surface. Alternatively, rather than further refining the polynomial surface, the sequence 100 may proceed to operation 180 where the surface is positioned.

Operation 140: Returning now to FIG. 2, a ratio Ri of a number of image data points above the surface over a number of image data points below the surface is calculated (as expressed earlier, this is the case of a non-limiting example of sequence 100 in which it is intended to find a good polynomial fit for the bottom surface of the object of interest; the ratio Ri would be inversed if, referring again to FIGS. 1a to 1g, the intent was to find a good polynomial fit to the peaks 12 of the gear). The ratio Ri may later be used as a rule for discarding image data points, in view of improving a speed of execution of the sequence 100.

In another embodiment, Rᵢ may be determined as the proportion of data points that are over a certain distance of the reference surface with the number of data points that are under this certain distance. In all embodiments, Rᵢ can also be used as a threshold to exit the iterations of the method when below a threshold close to 0 that would mean that no more data points are discarded.

Operation 150: Following operation 130 or 140, at least some image data points that are found above (for the present example) the polynomial fit calculated at operation 120 may be discarded from the 3D point cloud. In one variant, all image data points above the polynomial fit are discarded. In another variant a top half (or another predetermined fraction) of these points are discarded. In a further variant, the ratio Ri is evaluated and, if this ratio is found to be excessive, a lesser number of image data points are discarded.

The discarded data points may be data points on a single side of the polynomial surface (such as above the polynomial surface or below the polynomial surface), or on both sides of the polynomial surface. A threshold distance from the polynomial surface may be determined, and all data points may be discarded, on both sides of the polynomial surface, that are beyond the threshold distance from the polynomial surface. Whether the data points on one or both sides are discarded, and/or which side the data points are discarded from, may be determined based on a type of object represented in the 3D point cloud and/or a type of analysis being performed on the object. Whether the data points on one or both sides are discarded, which side the data points are discarded from, and/or other parameters for discarding data points may be determined based on user input.

Operation 160: As a result of the previous operation, a new 3D point cloud is obtained and replaces the original 3D point cloud for later operations. The new 3D point cloud may have less data points than the 3D point cloud obtained at operation 110.

Operation 170: After operation 160, iterations of operations 120 to 160 may end after zero or more discarding operations, when the remaining image data points provide a simplified 3D point cloud for allowing fitting a reference polynomial surface (e.g., a standard for an idealized version of the object of interest) that represents the reference surface of interest defined in the original point cloud. An evaluation of the surface as defined in the new 3D point cloud is made by considering one or more “breakout criteria” (breaking out from operations of the sequence 100 that have been executed up to this point) that may include a histogram of distances between the polynomial surface and the 3D point cloud and/or histograms of distances between the current iteration polynomial surface (or parametric surface) and the previous iteration polynomial surface (or parametric surface), a C2C distance, a C2M distance, thresholds on amplitude and/or standard deviation, and the like. These thresholds may be low numerical values that are predetermined by the user, the thresholds being low since the image data points may have been discarded from the point cloud, remaining points should be close to the polynomial surface. Another predetermined threshold may limit a number of image data point discarding operations. A further predetermined threshold may set a minimum percentage of image data points of the original 3D point cloud remaining in the new point cloud being evaluated at this operation or alternatively a percentage of image data points remaining in the new point cloud from the previous iteration.

If the evaluation reveals that the surface as defined in the new 3D point cloud is not appropriate (the breakout criteria are not met), the value of D as the number of degrees for the polynomial fitting process is reduced, being for example reset to 1, the number N for the number of image data point discarding operations is incremented from its current value, and the sequence 100 returns to operation 120.

It is to be noted that operations 140, 150 and 160 for discarding some of the image data points, and/or operation 170 for the evaluation of the surface as defined in the new 3D point cloud, may be omitted in some embodiments, and operation 130 may be followed directly by operation 180.

Operation 180: When the evaluation made at operation 170 shows that the breakout criteria are met, or following operation 130 if operations 140 to 170 are omitted, the polynomial surface is positioned (fitted or superimposed) on the surface of the object of interest in the original 3D point cloud. In the present non-limiting example, the polynomial surface is positioned on the bottom surface of the original 3D point cloud, for example as illustrated in FIG. 1g.

Operation 190: An analysis of the object of interest may take place. A distribution of image data points in the 3D point cloud, for example a distance of each data point from the bottom surface (or other surface, if not the bottom surface) as defined by the polynomial surface, may be presented in the form of a histogram for comparison with an idealized version of the object of interest. Compliance with manufacturing tolerances (for a new object), wear and tear and/or remaining lifetime (from a used object) may be evaluated. Various measurements of the object of interest may be taken, depending on the type of object in the 3D point cloud and/or the type of analysis being performed. For example if the object of interest is a body part, a length, circumference, and/or other measure of the body part may be taken based on the distance distribution obtained from each point of the original 3D point cloud to the polynomial surface.

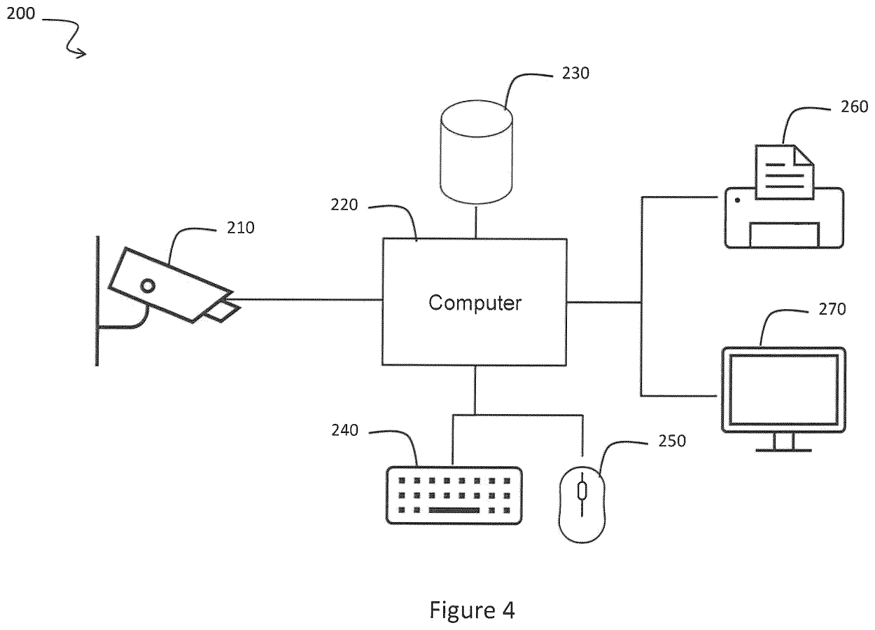

FIG. 4 illustrates a system for analysing a multidimensional surface. A system 200 includes a camera 210 and a computer 220, and may also include a database 230, a keyboard 240, a pointer device (mouse) 250, a printer 260 and a display device 270. The computer 220 is communicatively connected to the camera 210, the database 230, the keyboard 240, the pointer device 250, the printer 260 and the display device 270, either via cables or via wireless connections. When at least some of the components of the system 200 are linked via wireless connections, these components may be physically co-located or may be distant. A user of the system 200 may use the keyboard 240 and the pointer device 250 to enter data and commands to control an operation of the system 200. The database 230 may store, in non-limiting examples, one or more of the above-mentioned predetermined parameters (e.g., maximum number of iterations between operations 120 and 130, thresholds used at operations 130 and/or 170, and the like) and/or information useable at operation 190 to perform the analysis of the object of interest. Once the sequence 100 is completed, the computer 220 may cause the database 230 to store results of the sequence 100 for later reference.

The camera 210 may be a standard 3D digital camera, a depth camera, a 3D scanner, and the like, providing image information sufficient to generate a 3D point cloud. A plurality of images may be combined, for example 2D images obtained from a 2D digital camera, to generate the 3D point cloud. The camera 210 is selected to have a sufficient resolution for the task at hand. For some applications, a precision of about one millimeter may be sufficient. For other applications, a precision to the level of one micron, or one tenth of a micron, may be sufficient. Any level of precision sufficient for a particular application is within the scope of the present disclosure.

The computer 220 receives image information from the camera 210. Depending on characteristics of the camera 210, the computer 220 may receive a 3D point cloud, or may receive a plurality of 2D images and combine these images using conventional techniques to generate the 3D point cloud. The computer 220 receives data and commands from the keyboard 240 and/or the pointer device 250, for example for triggering the capture of images by the camera 210 and for initiating operations of the sequence 100. Results of the method for analysing the multidimensional surface of the object of interest may be displayed on the display device 270 and/or printed on the printer 260 and/or stored in the database 230. These results may include, for example and without limitation, one or more of (i) parameters used in the operations of the sequence 100, (ii) images captured by the camera 210, (iii) the 3D point cloud as initially provided by the camera 210 or prepared by the computer 220 when combining a plurality of 2D images, (iv) successive images of the polynomial surface obtained in the course of the sequence 100, (v) numbers of iterations between operations 120 and 130 of the sequence 100 and/or between operations 120 and 170 of the sequence 100, (vi) image of the polynomial surface superimposed on the 3D point cloud, (vii) performance requirements obtained from the database 230, and (viii) histograms as described hereinabove.

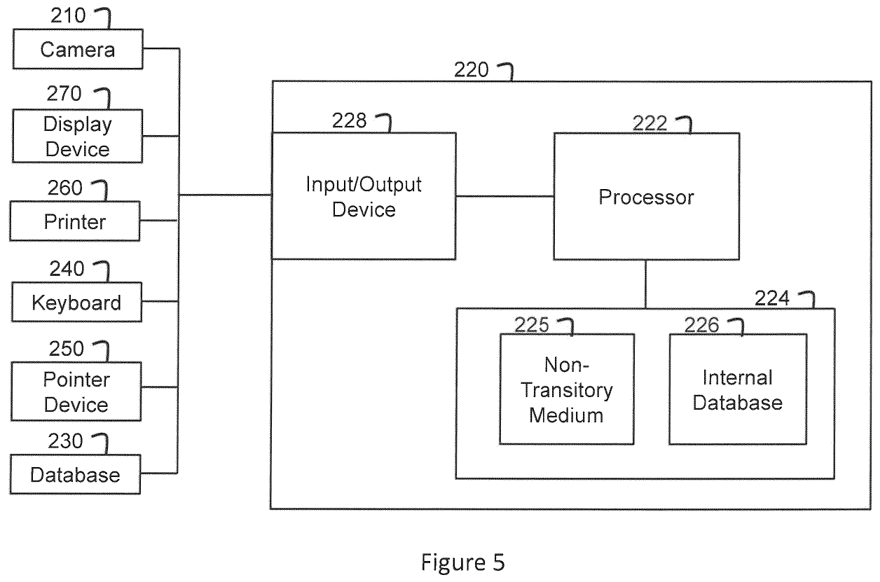

Each of the operations of the sequence 100 may be configured to be processed by one or more processors, the one or more processors being coupled to a memory device. For example, FIG. 5 is a block diagram of the computer 220. On FIG. 5, the computer 220 includes a processor or a plurality of cooperating processors (represented as a processor 222 for simplicity), a memory device or a plurality of memory devices (represented as a memory device 224 for simplicity), an input/output device or a plurality of input/output devices (represented as an input/output device 228). Use of distinct input devices and output devices is also contemplated. The processor 222 is operatively connected to the memory device 224 and to the input/output device 228. The input/output device 228 allows the processor 222 to communicate with the camera 210, the database 230, the keyboard 240, the pointer device 250, the printer 260 and the display device 270. The memory device 224 may store, in an internal database 226, the 3D point cloud being processed in the course of the sequence 100, as well as some of the above-mentioned parameters, for example predetermined thresholds. The memory device 222 may comprise a non-transitory computer-readable medium 225 for storing instructions that are executable by the processor 220 for executing the operations of the sequence 100.

Considering at once FIGS. 4 and 5, it is contemplated that, in many applications, functions and features of the camera 210, the computer 220, the database 230, the keyboard 240, the pointer device 250 and the display device 270 may be integrated in an intelligent mobile terminal or in a tablet (not shown), for example an iPhone™, an iPad™, or a terminal incorporating an Android™ operating system.

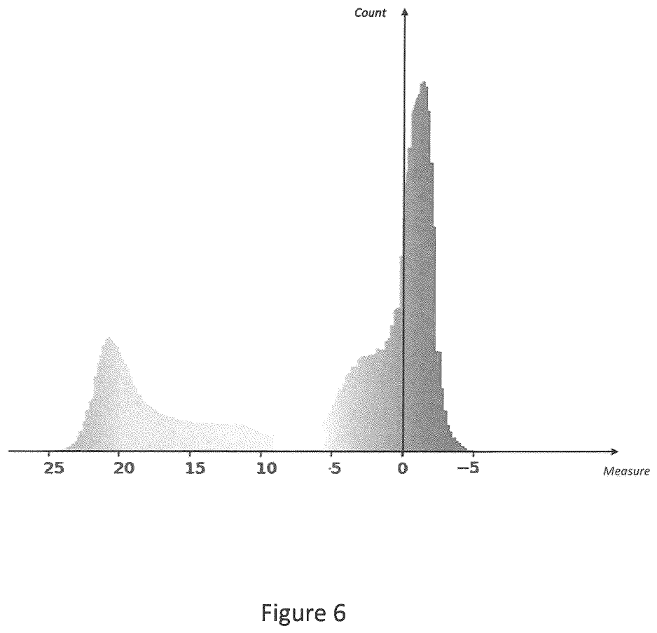

FIG. 6 is a histogram of cloud to mesh (C2M) signed distances used to evaluate an intermediate result of the method for analysing a multidimensional surface. The histogram shown on FIG. 6 is an example of the C2M histogram obtained at operation 120 and/or 170 of the sequence 100.

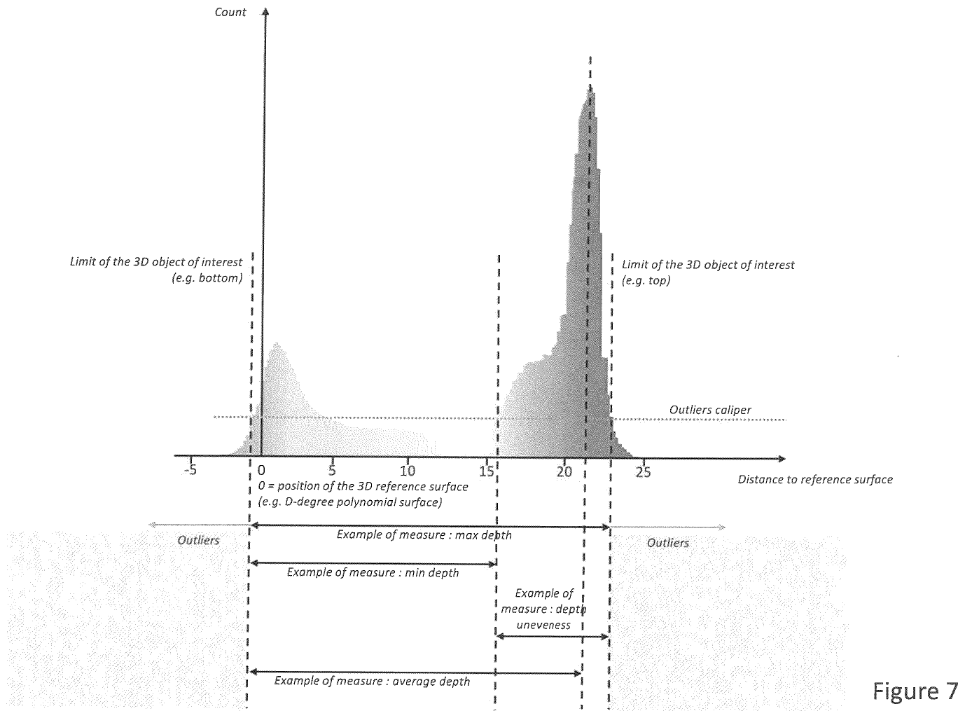

FIG. 7 is an example of depth measures obtained from a histogram of distances of a surface of an object (e.g. a gear) relatively to a 3D reference surface (polynomial or any type of parametric surface) that has been positioned on the 3D point cloud of interest according to the present method. The histogram was produced in operation 190 of the sequence 100. The polynomial surface calculated in the sequence 100 was used as a base value (depth equal to 0 millimeter). Distances of each point from the original 3D point cloud obtained at operation 110 have been plotted in view of the polynomial surface in order to obtain the histogram. In the example of a gear analysis, a level of unevenness of the top surface (top of the gear's teeth), minimum, average and maximum height (or depth) of the surface are evaluated. These values may be compared to design specifications for a new product, or to minimum specifications for a used product.

As part of the subsequent analysis presented on FIG. 7, a horizontal caliper can be calculated to determine small values counts/bins that can be considered as outliers of the 3D object of interest. Those outliers can be noisy vertices, well known in the art of 3D photogrammetry reconstruction methods, or small elements that are not part of the object of interest, or acceptable factory default on a manufactured object. Alternatively, measures can be considered on the full range of distances of the histogram.

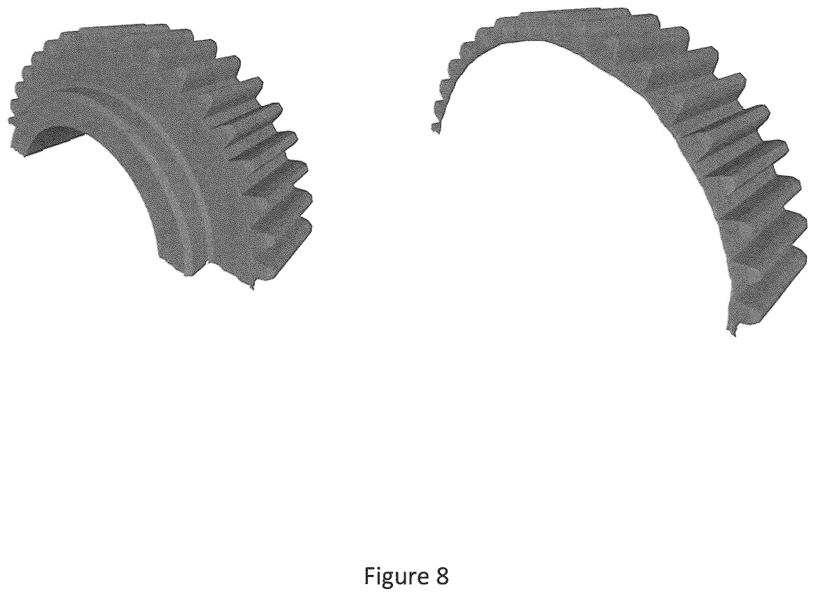

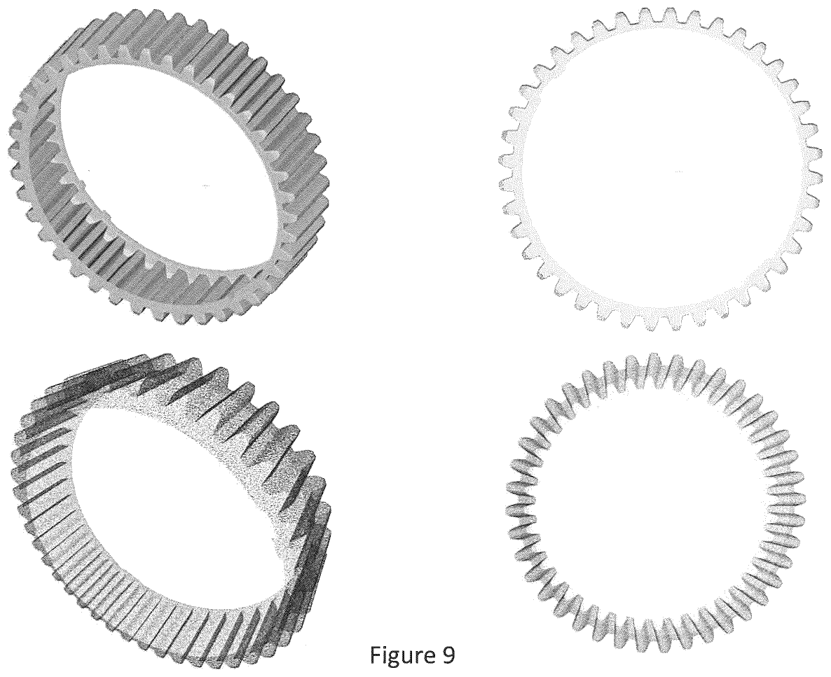

FIG. 8 is a 3D point cloud showing a computed-aided design (CAD) perspective view of a gear. It is desired to study a surface of gear teeth instead of a complete surface of the gear. Therefore, FIG. 9 is a 3D point cloud showing extracted gear teeth of the gear of FIG. 8.

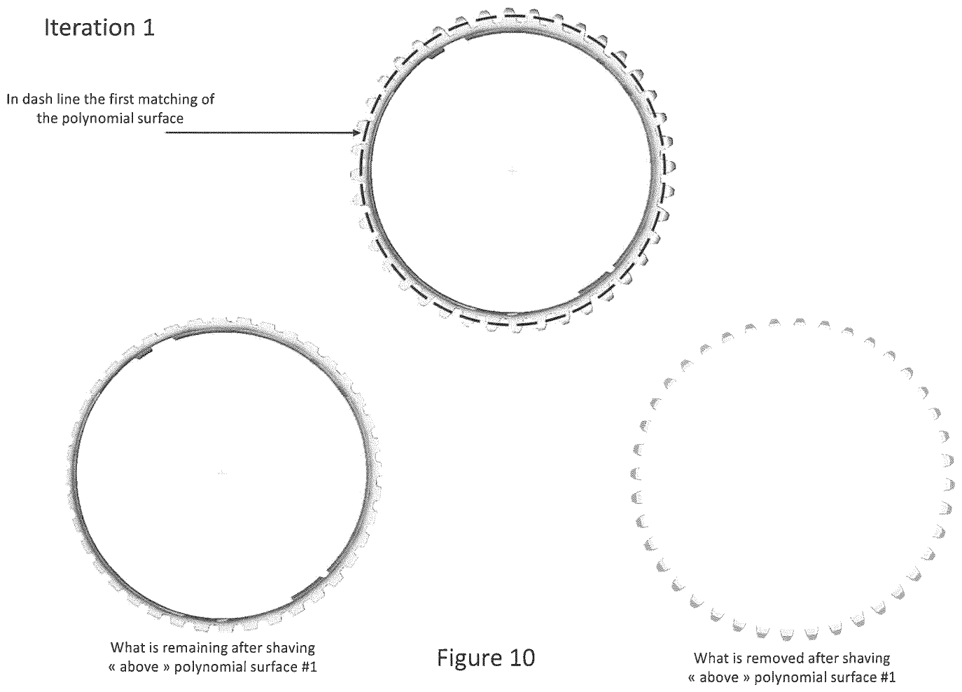

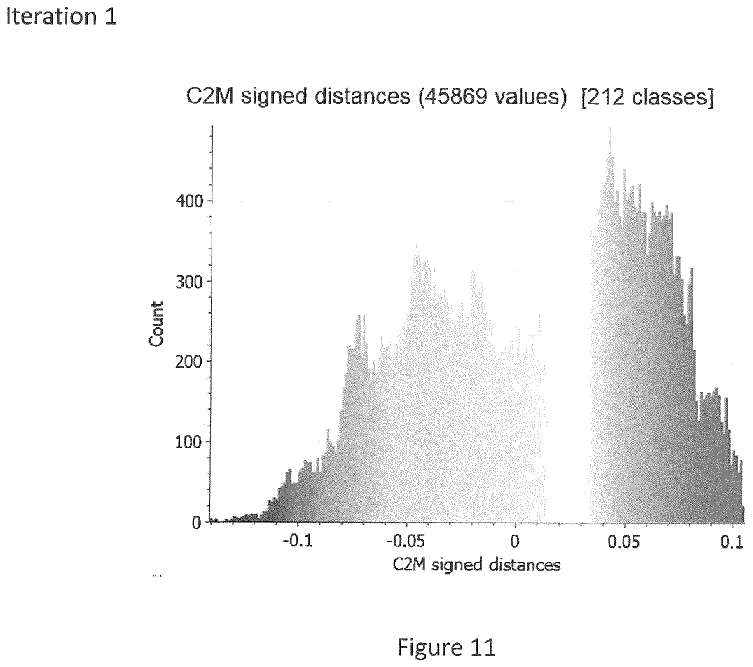

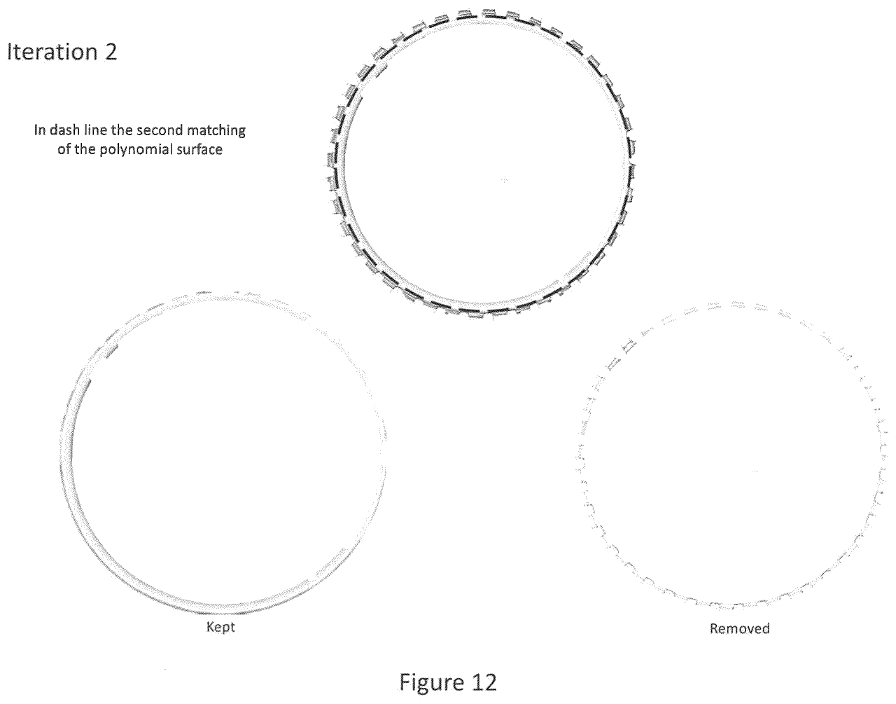

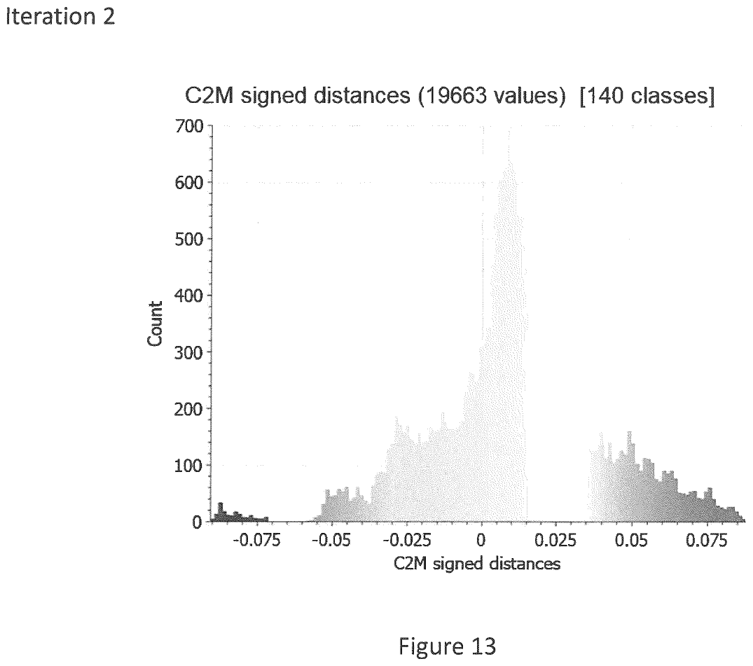

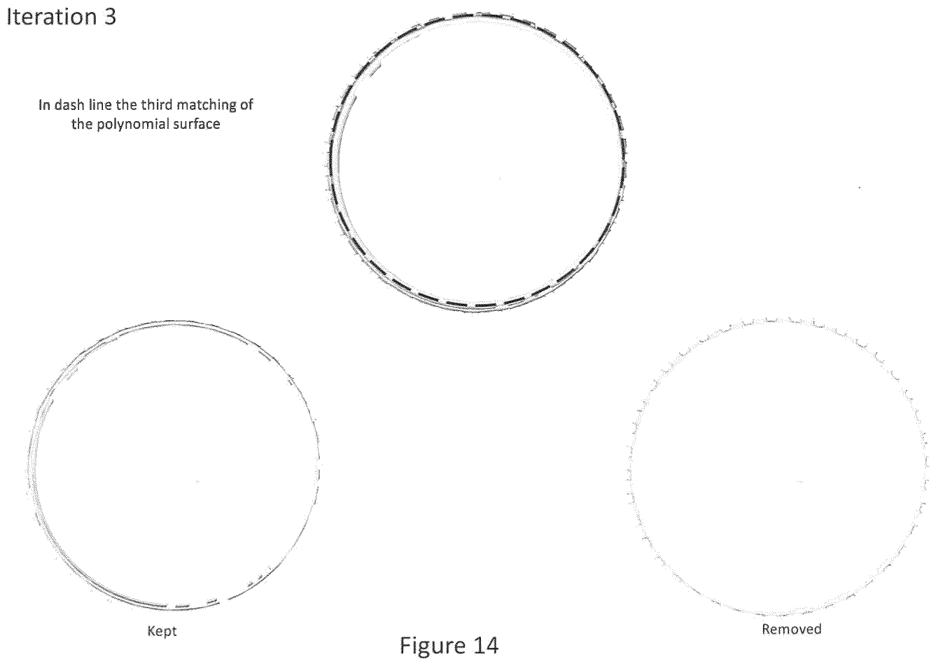

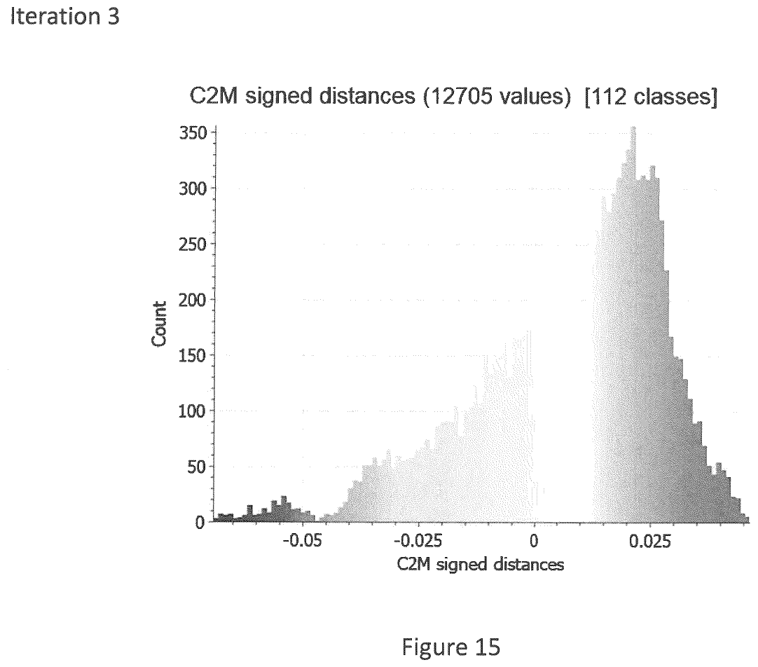

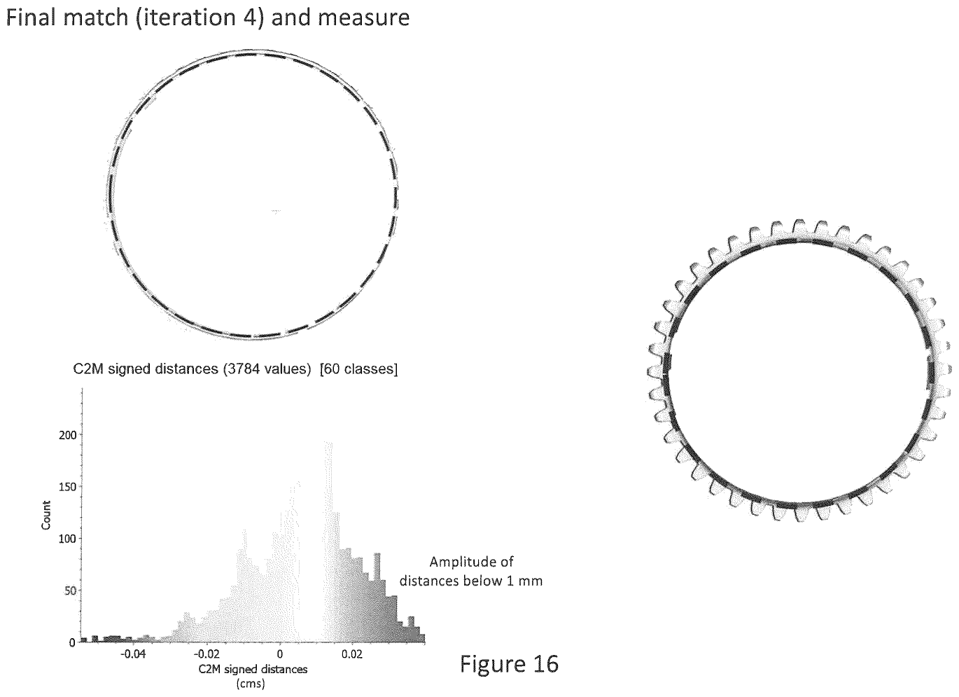

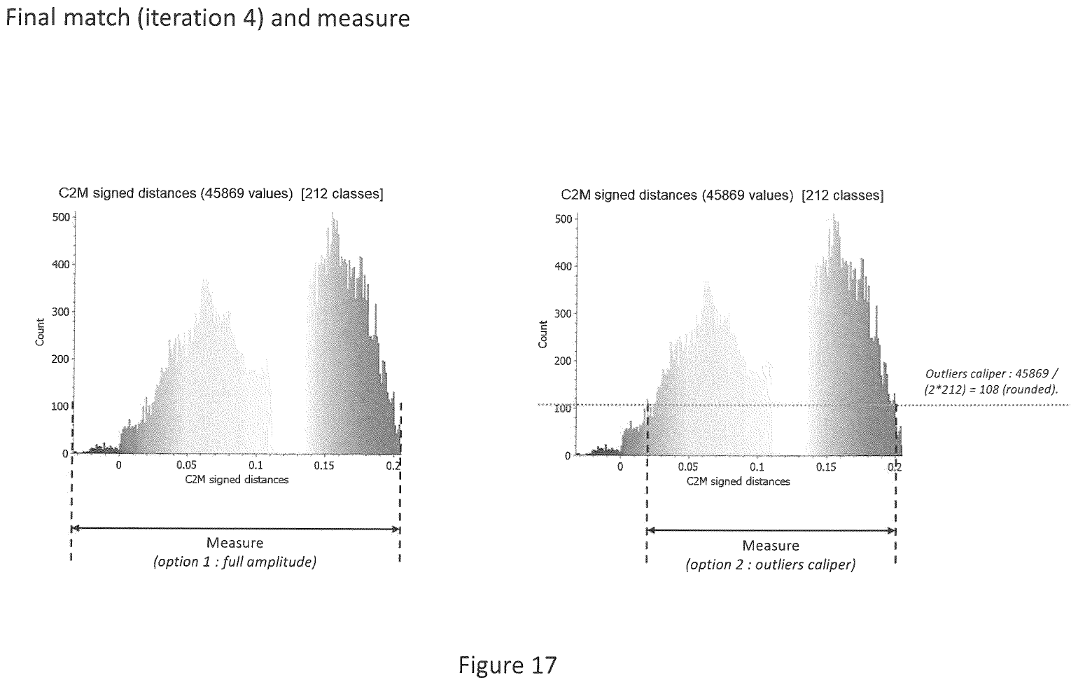

Several polynomial fit iterations are then executed on the image of the extracted gear teeth. FIG. 10 is a skimmed/shaved 3D point cloud of the extracted gears of FIG. 9 after a first polynomial fit iteration. The removal of 3D data points is done using the histogram of FIG. 11, which is a histogram of gear depths obtained from the 3D point cloud of FIG. 10, using the same color for each bin of the histogram as the one of each vertex shown in FIG. 10. In this example, the final iterated 3D reference surface (D-Degree polynomial surface) should be fitted to the bottom of the 3D object of interest (valleys/bottom of the gear), so the 3D data points that are removed will be above the surface of FIG. 10, meaning the data points that have a positive distance on the histogram of FIG. 11 will be removed. FIG. 12 is a 3D point cloud of the extracted gears of FIG. 9 after a second polynomial fit iteration. FIG. 13 is a histogram of gear depths obtained from the 3D point cloud of FIG. 12. FIG. 14 is a 3D point cloud of the extracted gears of FIG. 9 after a third polynomial fit iteration. FIG. 15 is a histogram of gear depths obtained from the 3D point cloud of FIG. 14. FIG. 16 is a 3D point cloud of the extracted gears of FIG. 9 after a fourth and final polynomial fit iteration as concluded from the histogram on the same FIG. 16 if the chosen stop criteria would be to have an amplitude of distances to the reference surface under 1 mm (which is the case for the histogram of FIG. 16). The final obtained polynomial surface is applied on the original point cloud for subsequent measures and analysis. FIG. 17 is a histogram of gear depths obtained from the 3D point cloud of FIG. 16. These histograms may for example be used to evaluate the compliance of a gear manufactured as per a CAD model to design specifications.

In this example as shown in FIG. 17, different approaches can be defined by the skilled person, such as i) consider the full amplitude of the distances histogram to obtain the desired measure; ii) use an outlier caliper to exclude small bins in the histogram according to well know statistical rules, such as dividing the total number of values by a multiplicator of the number of count bars/bins in the histogram (twice the number of bins in this example).

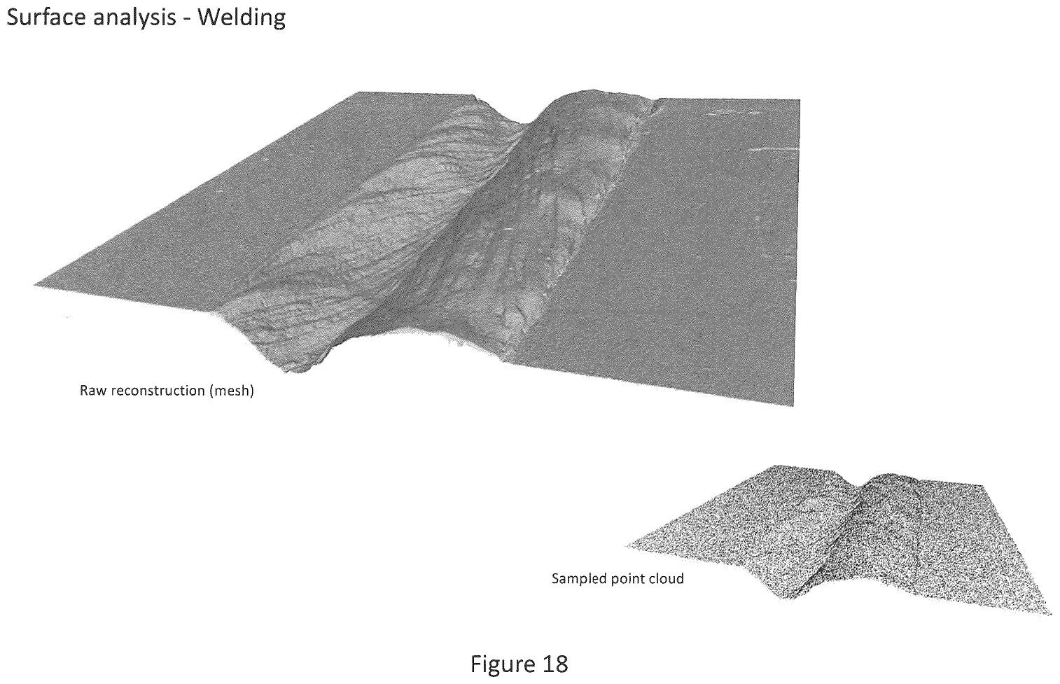

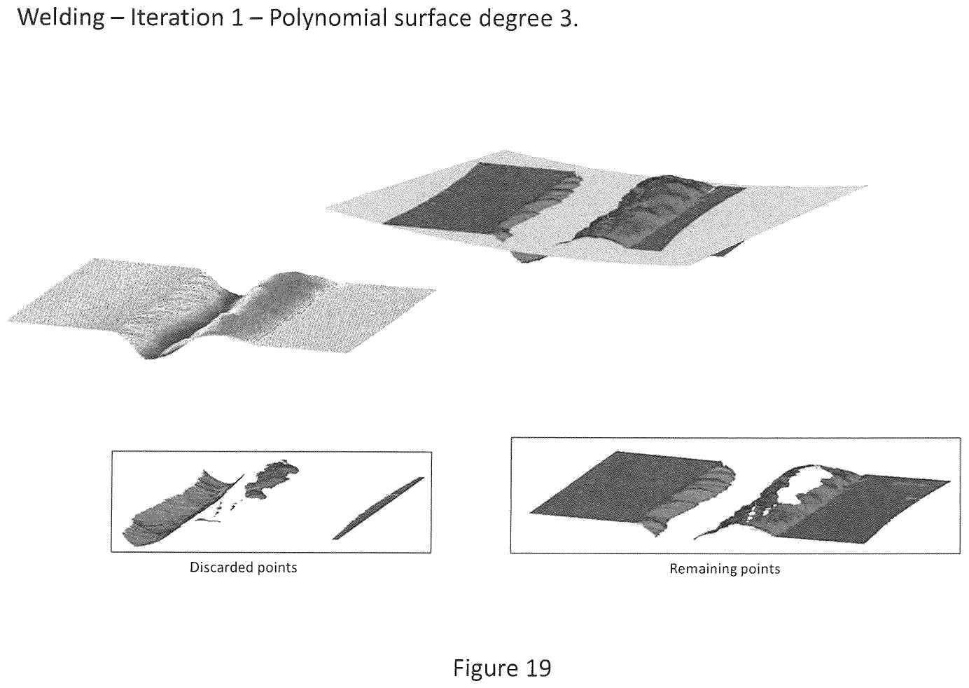

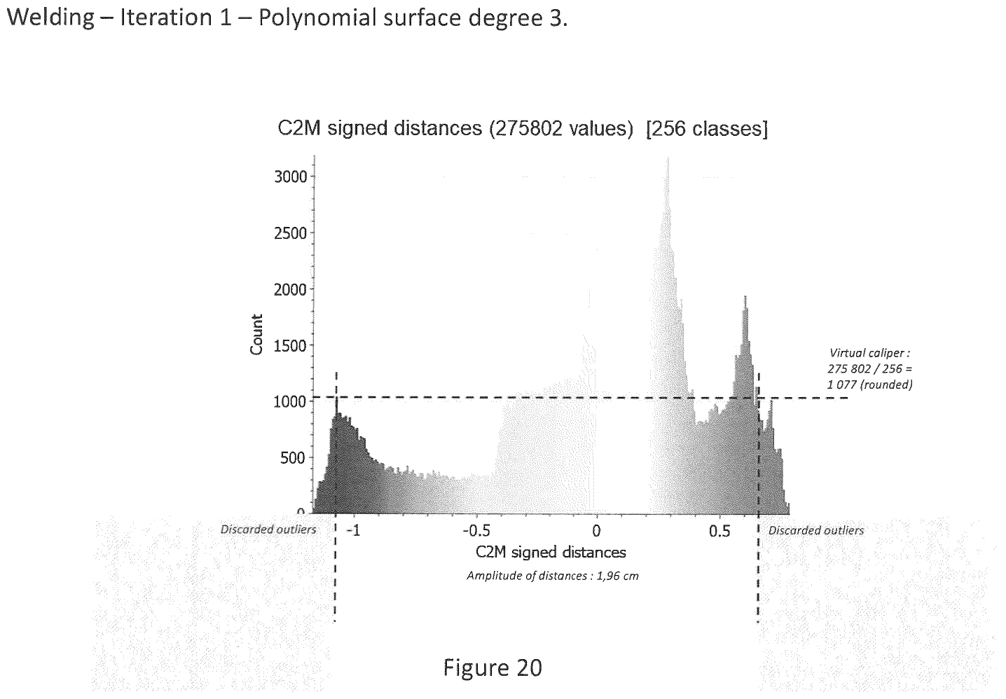

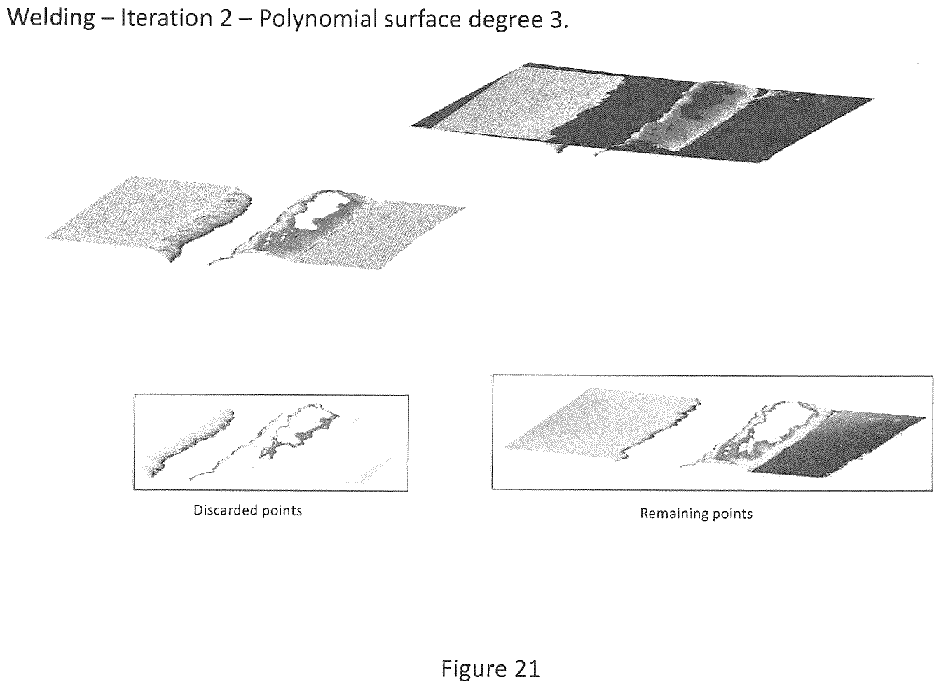

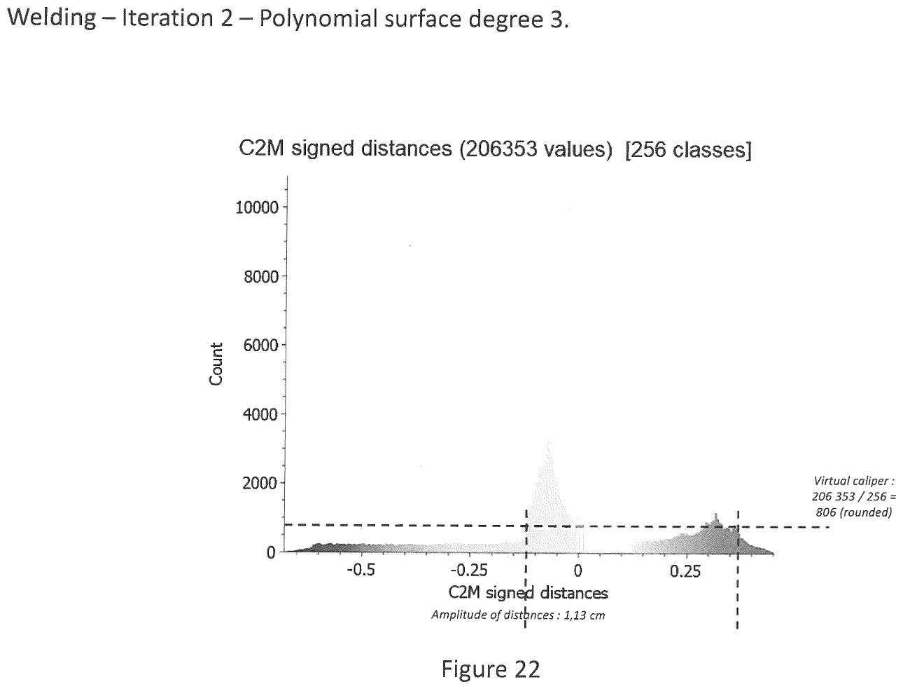

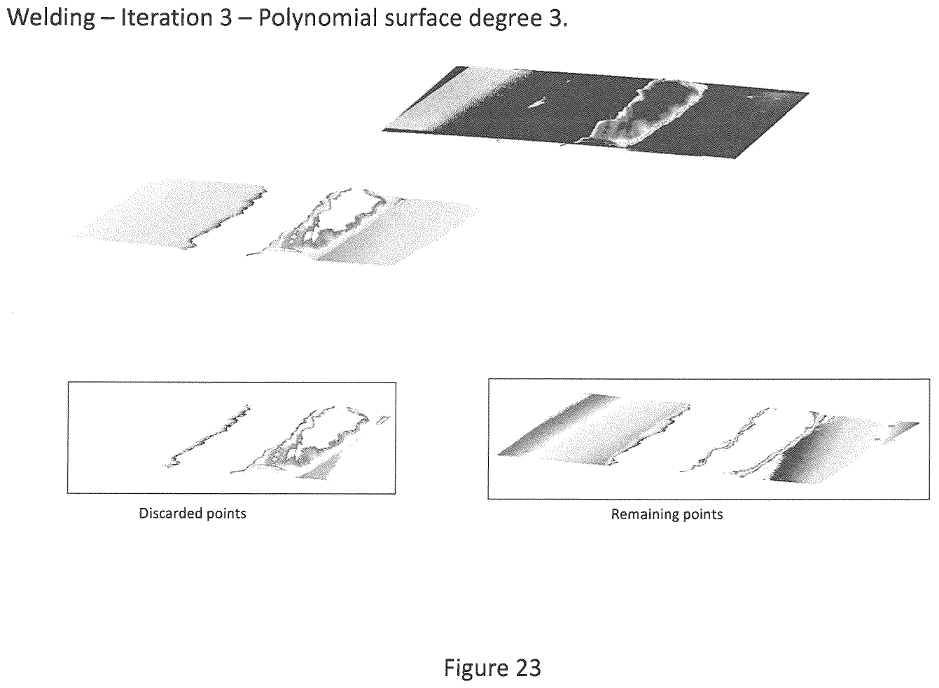

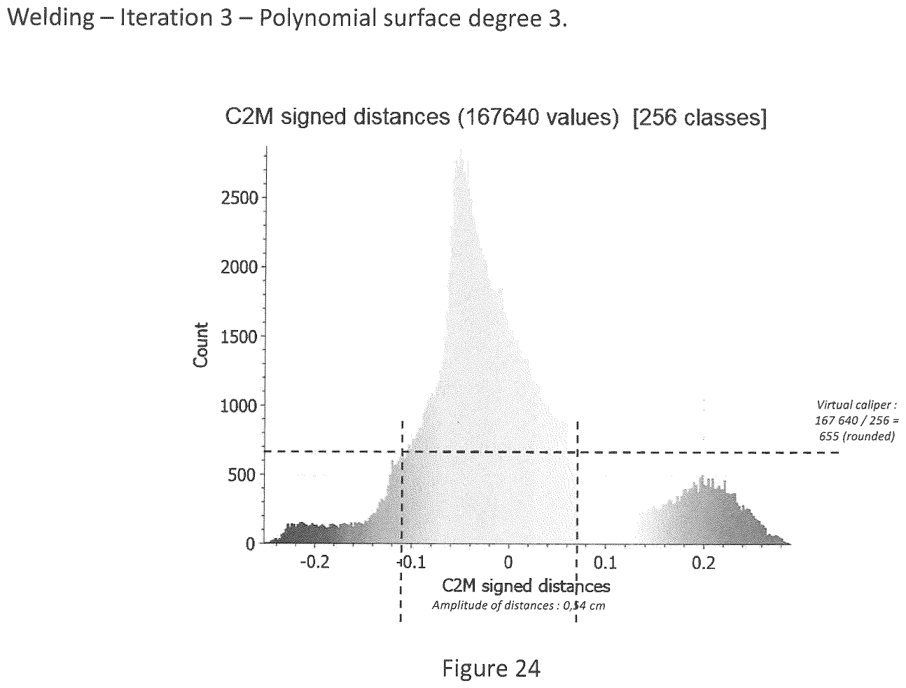

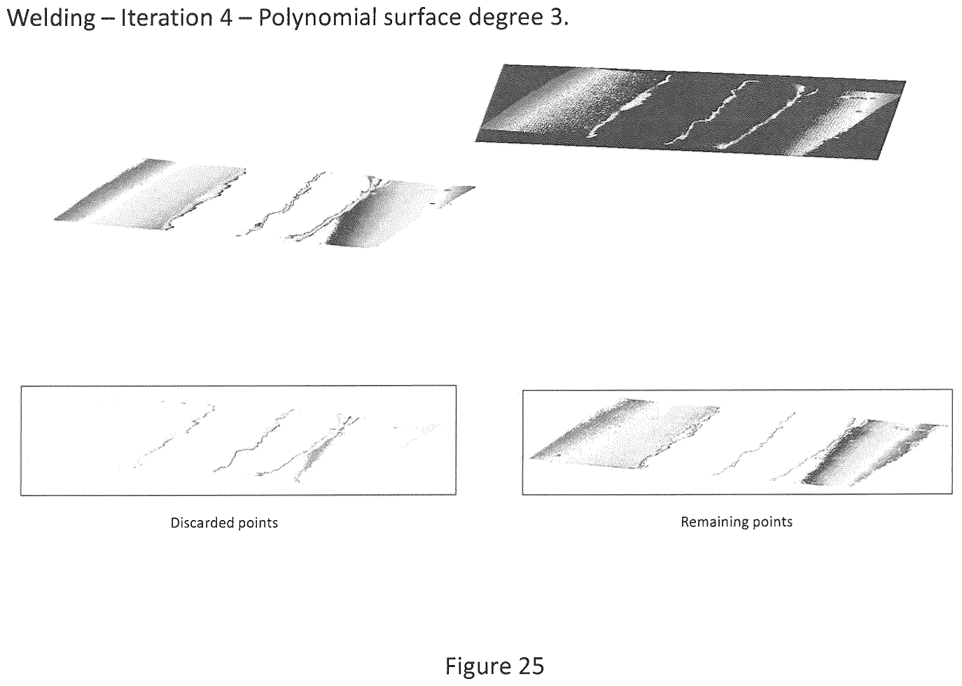

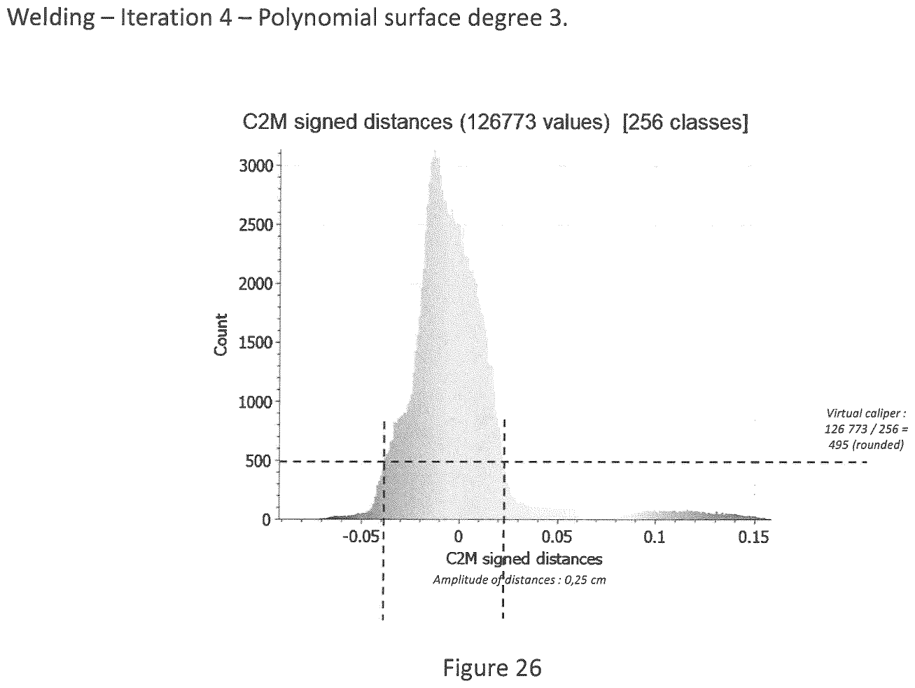

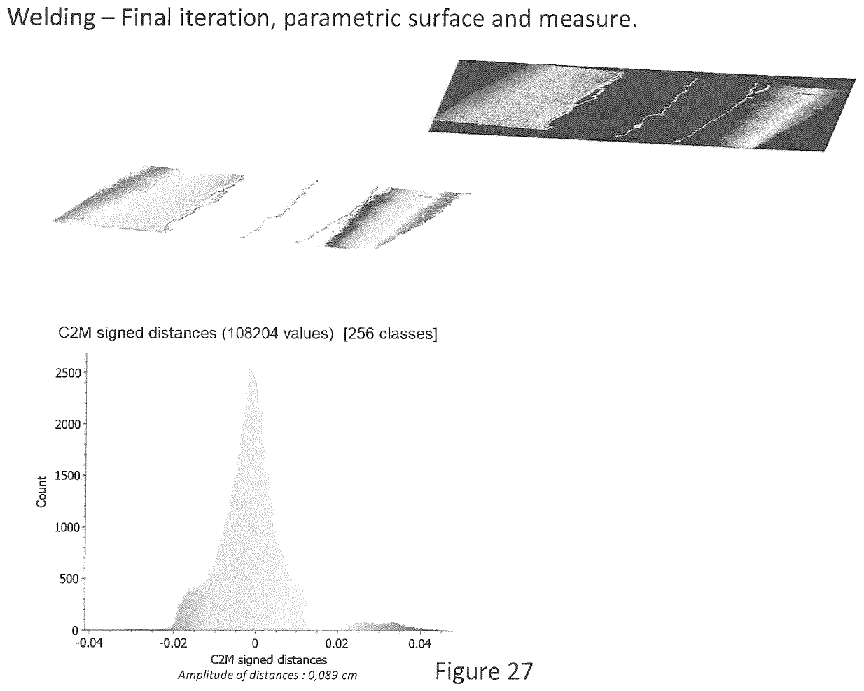

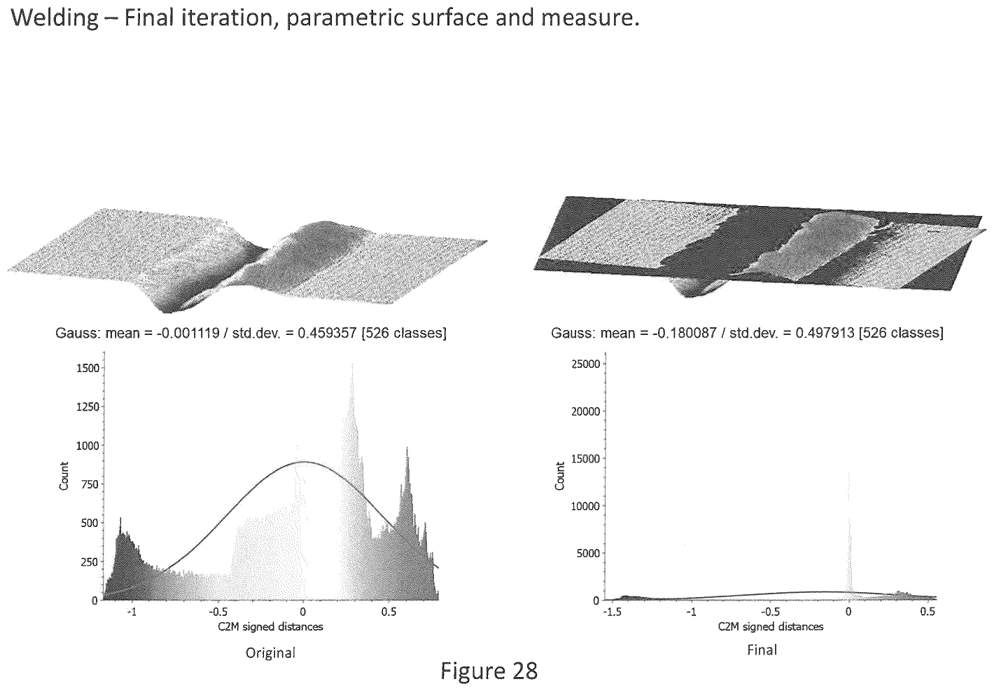

As another example of the application of the method, FIGS. 18 to 28 describe the analysis of the quality of a weld. In this application, a 3D reference surface is fitted (here, a polynomial surface of degree 3) in an iterative way and at each iteration, 3D data points are removed if too far from the 3D reference surface, both above and below the 3D reference surface. FIG. 18 shows a 3D reconstruction and the related point cloud of the welding area to analyze. FIG. 19 shows the fitting of a degree 3 polynomial surface as a first iteration and the discarding of outliers according to the outliers caliper of FIG. 20. FIGS. 21 to 27 show the subsequent iterations until a threshold of 1 mm is reached for the maximum amplitude of distances of points of the 3D object of interest to the 3D reference surface in FIG. 27, where the iterations stop. The obtained 3D reference surface, positioned in an average position of the welding area, is fitted on the original point cloud of FIG. 18 and a last histogram is generated, thus giving a more accurate representation of what an acceptable welding should ideally be as shown on FIG. 28. A statistical analysis based on mean and standard deviation of the histogram generated from the iterated reference surface shows that this welding should be qualified as bad according to the chosen criteria of 1 mm deviation (absolute mean value is 1.8 mm). On the contrary, using a single non-iterated approach would have led to considering this welding as good (absolute mean value is 0.011 mm).

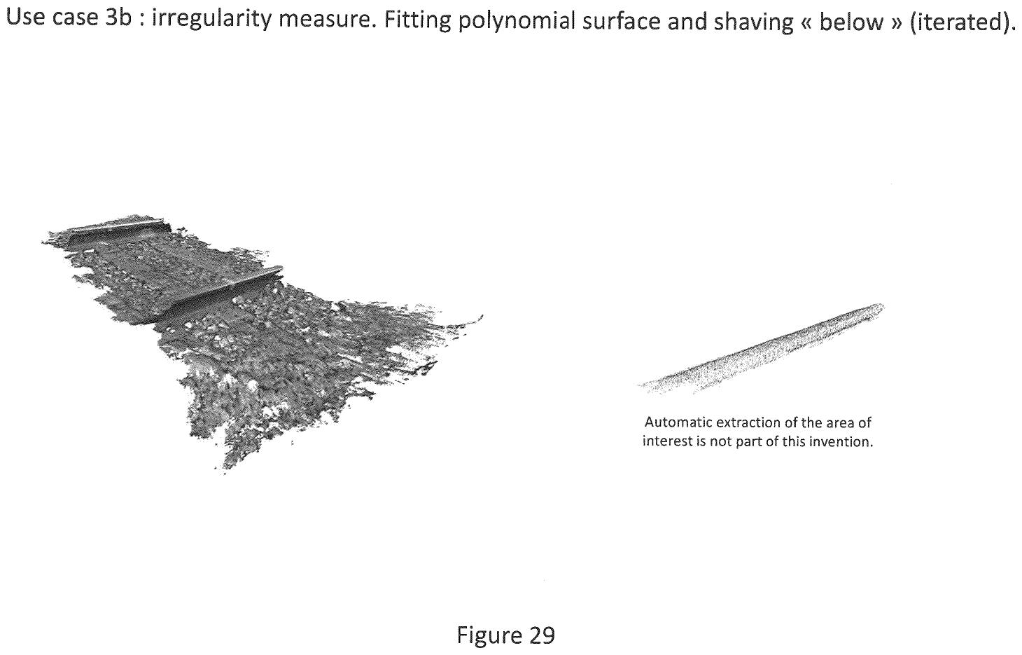

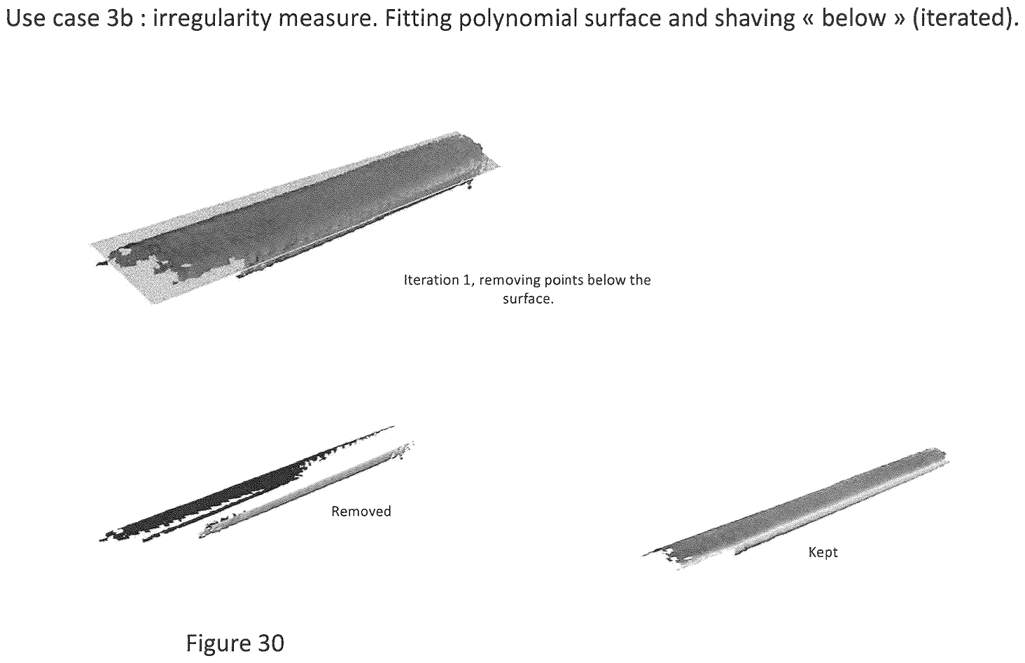

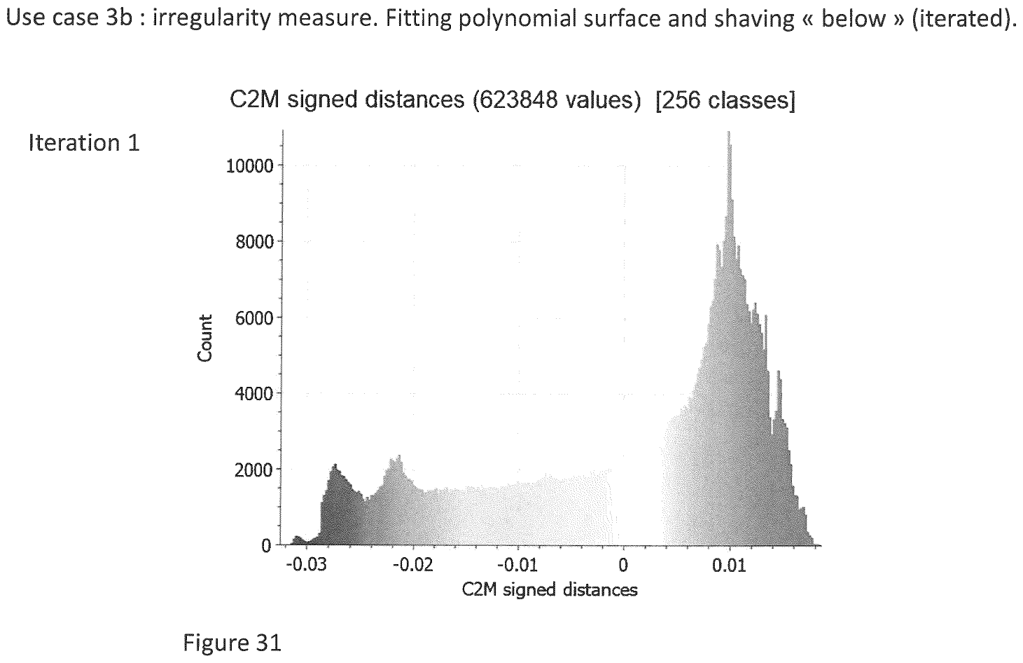

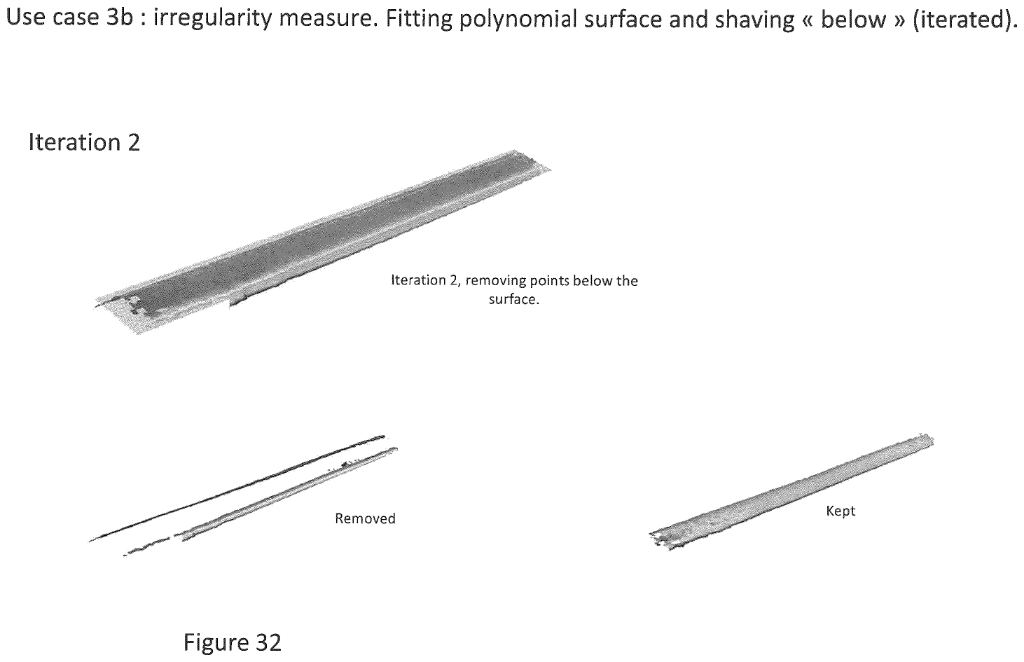

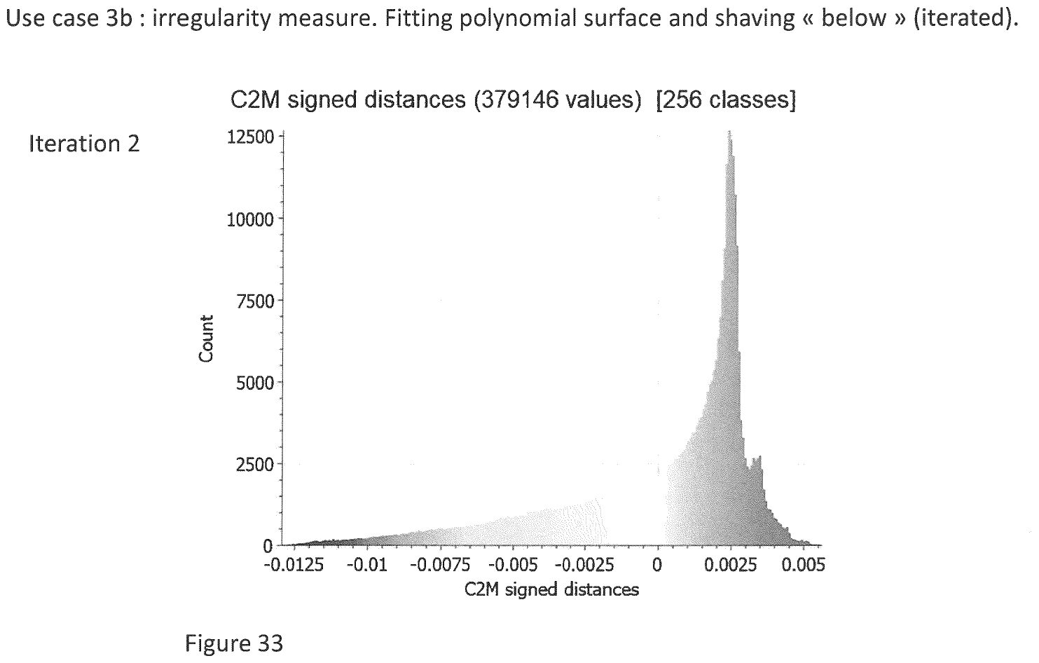

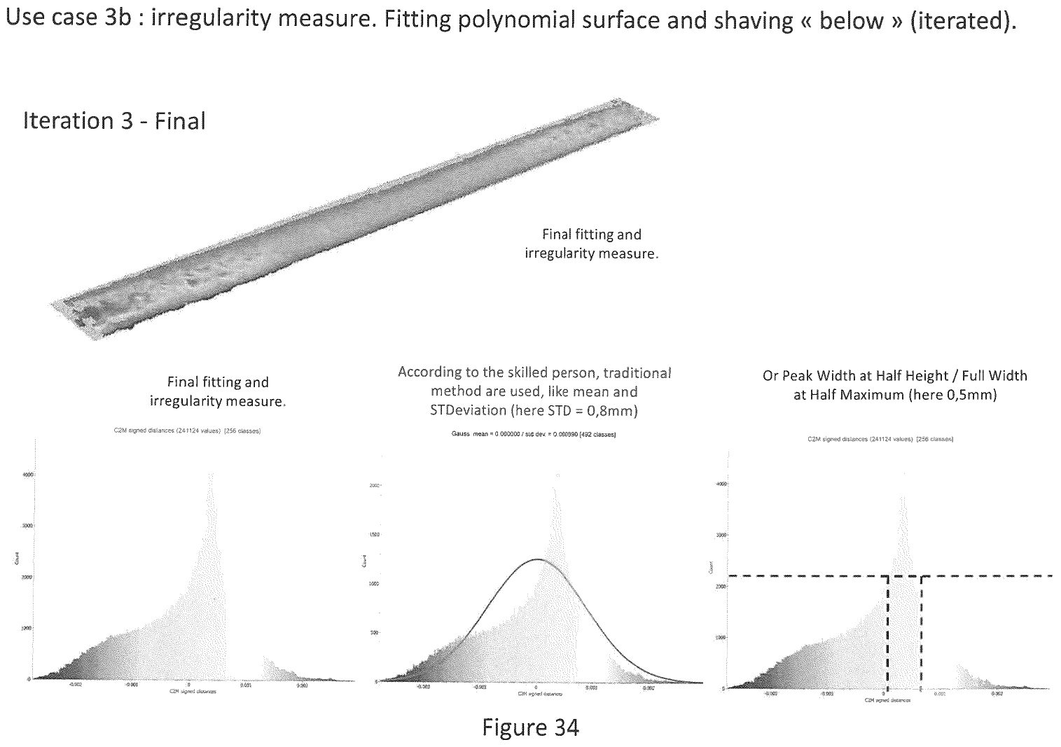

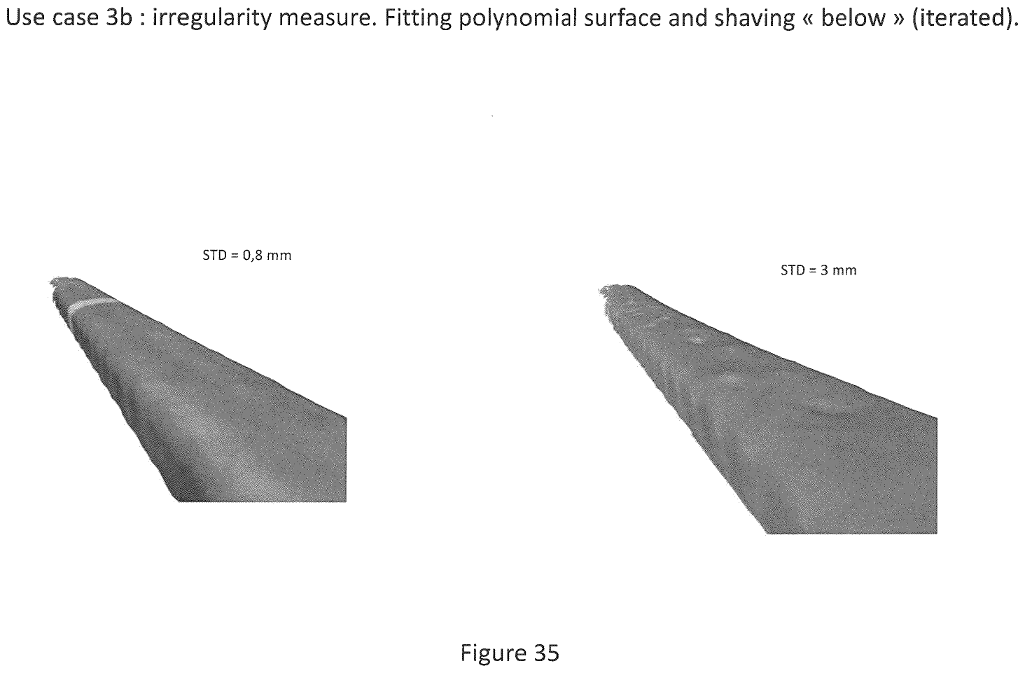

As another example of the application of the method, FIGS. 29 to 35 describe the analysis of the regularity of the top part of a rail. The 3D reference surface is a super ellipsoid iteratively fitted on the top of the rail with removing points below the said reference surface. In this example, the final iteration of the 3D reference surface of FIG. 34 is not fitted on the original point cloud in FIG. 29 since the area of the interest to analyze is purely the surface of the rail. The iteration stop criteria is based on the percentage of removed points from an iteration to a consecutive one and the output measure is the standard deviation of the distances of the final iterated representation of the 3D point cloud of interest to the final iteration of the 3D reference surface. Two different examples are given in FIG. 35.

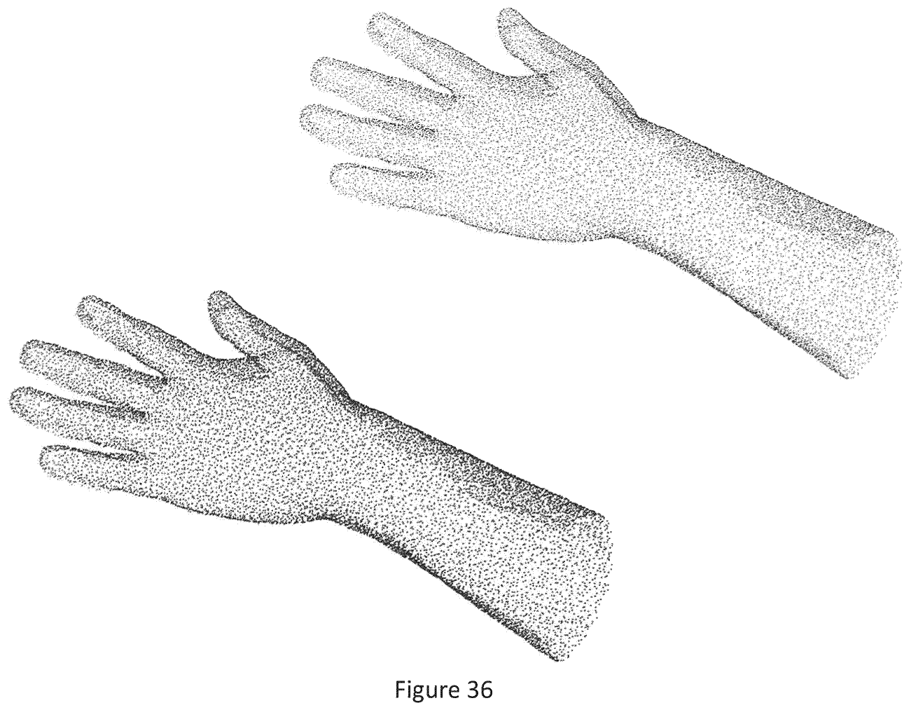

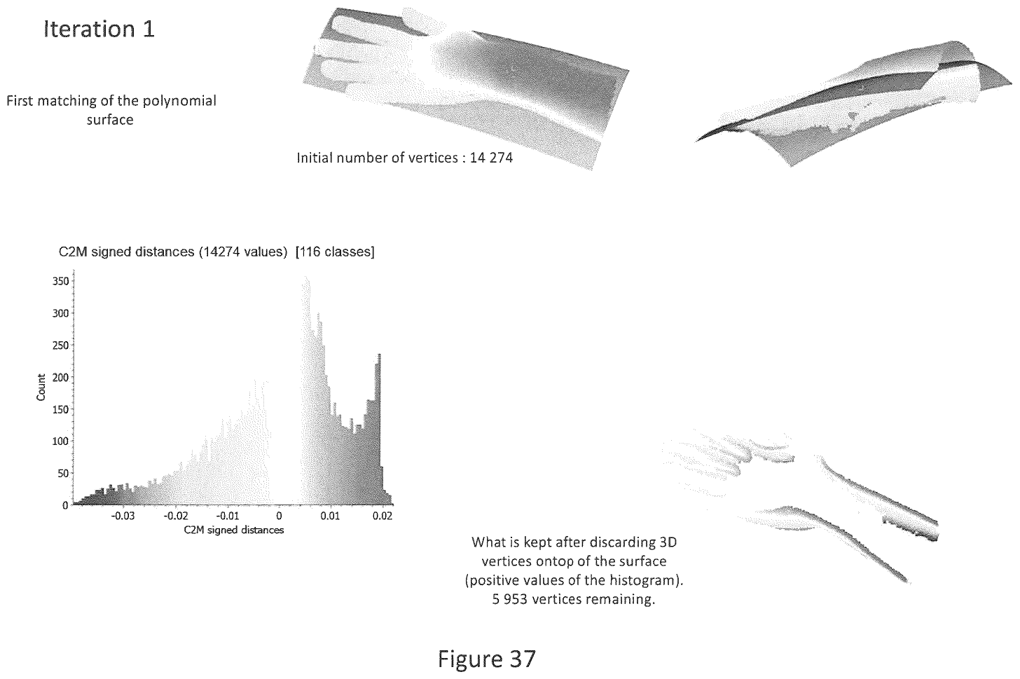

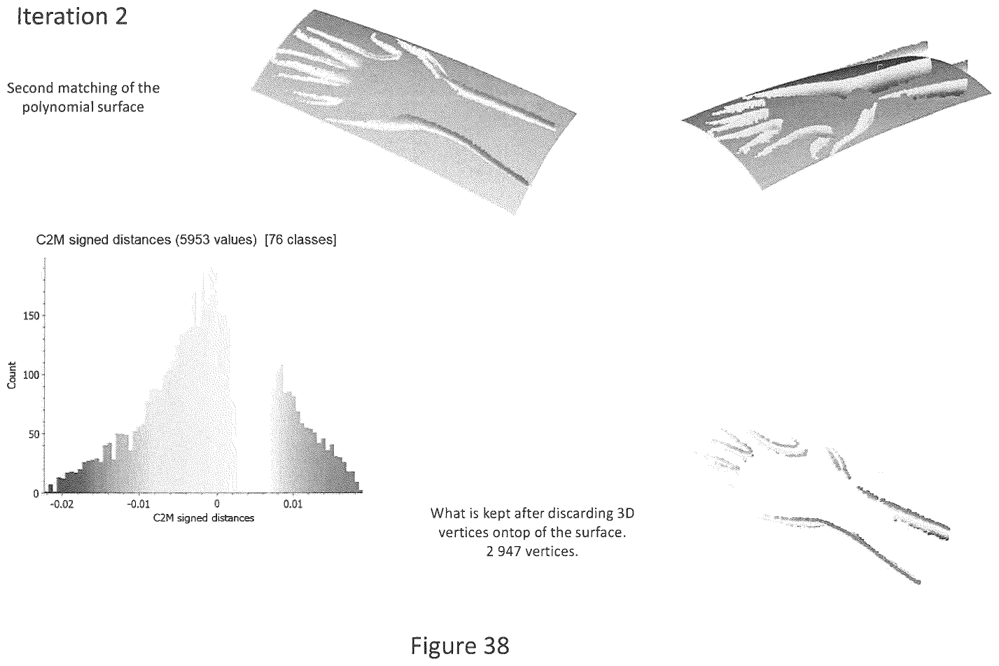

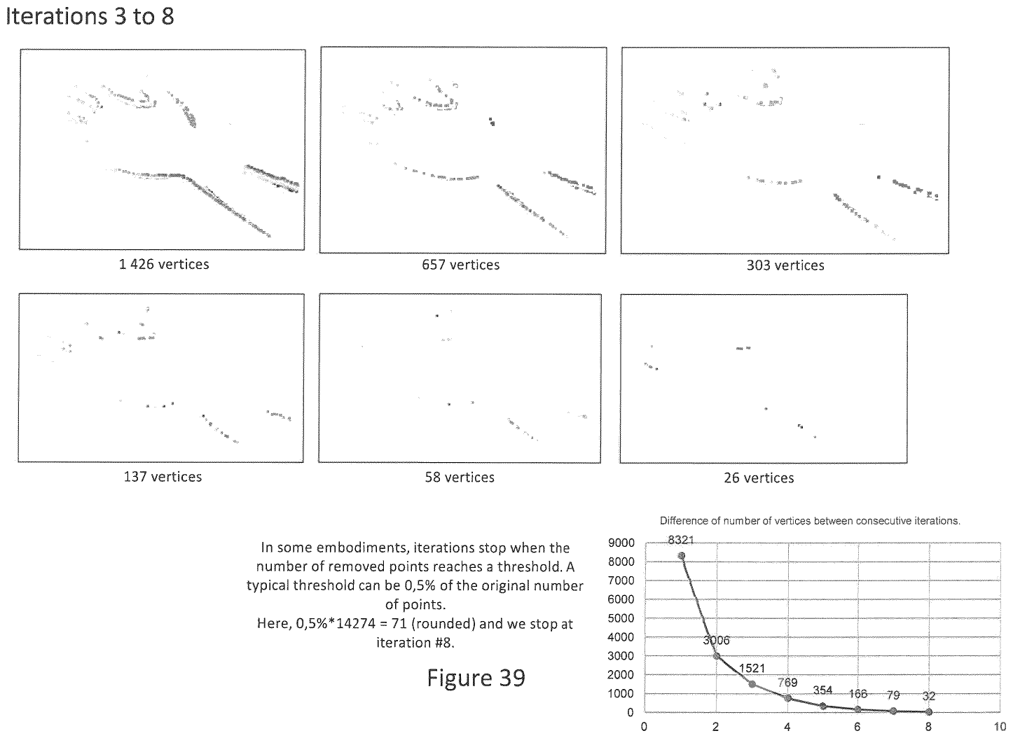

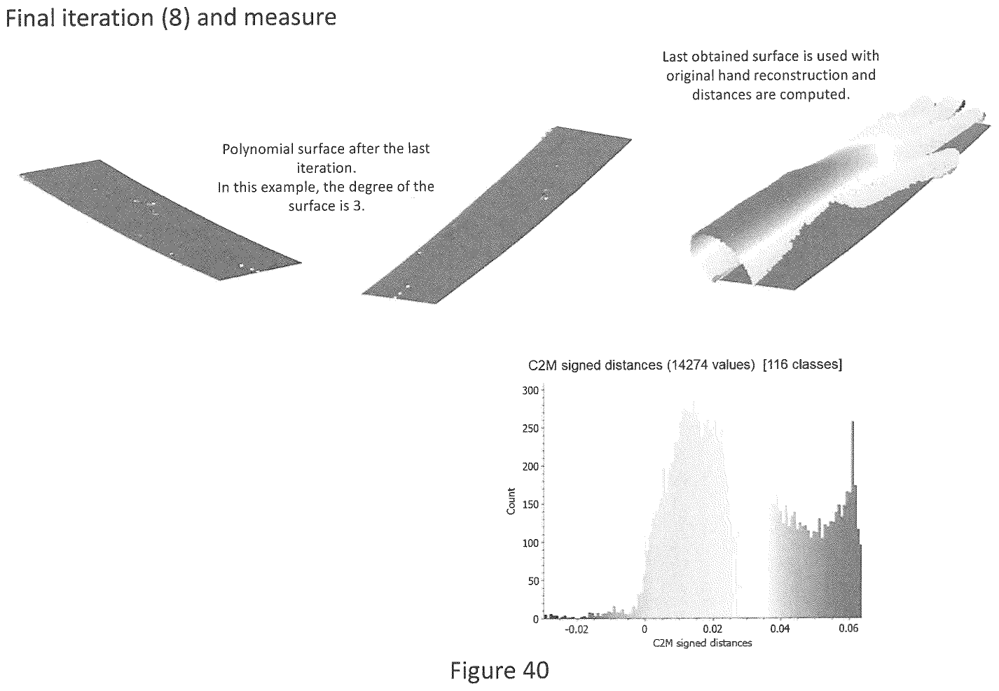

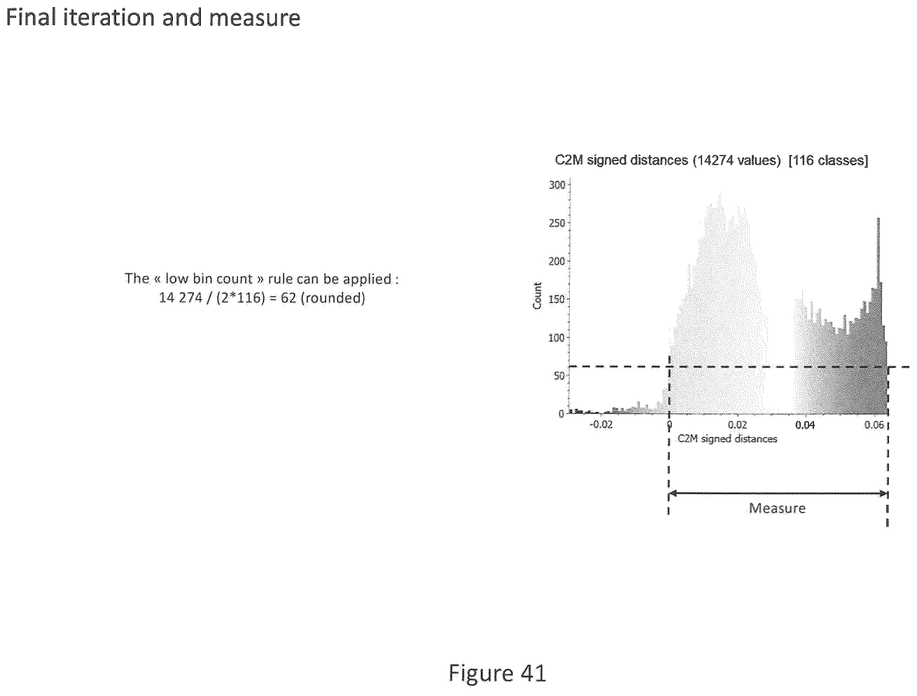

As another example of the application of the method, FIGS. 36 to 42 describe a way to obtain the height of a human wrist. The iteratively fitted 3D reference surface is a D-degree polynomial surface, the 3D data points removals happen above the surface and the stopping criteria is the number of removed 3D data points from an iteration to a consecutive one (0.5% of the number of 3D data points of the original 3D point cloud is reached at iteration 8 as shown on FIG. 39). In FIG. 40, the last iterated polynomial surface is fitted on the original point cloud and the measure is obtained in FIG. 41 by applying the outlier caliper removal method.

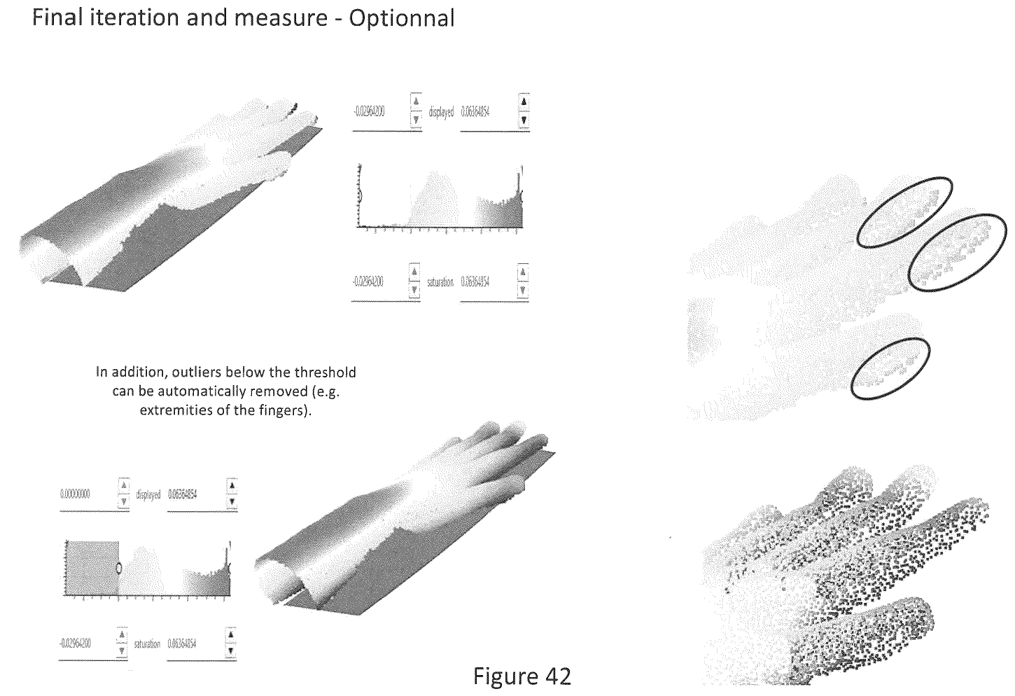

As an added value of the method, the outlier calliper removal method can be used to remove real outliers from the original point cloud as described on FIG. 42.

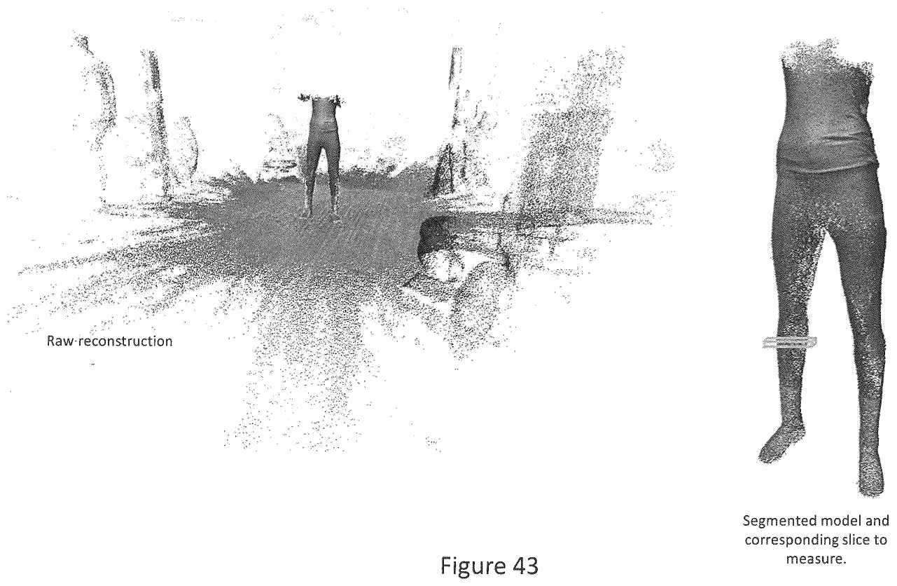

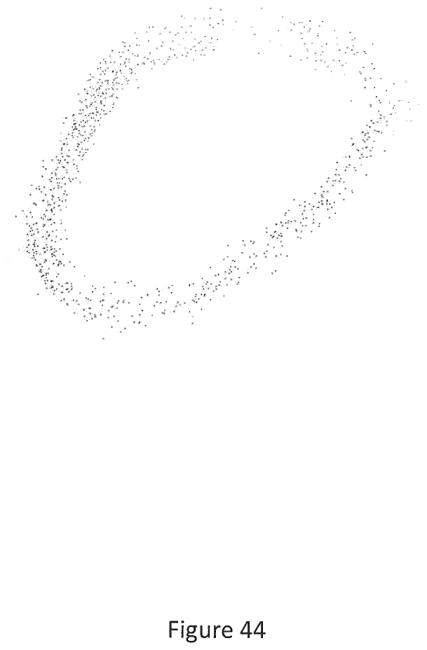

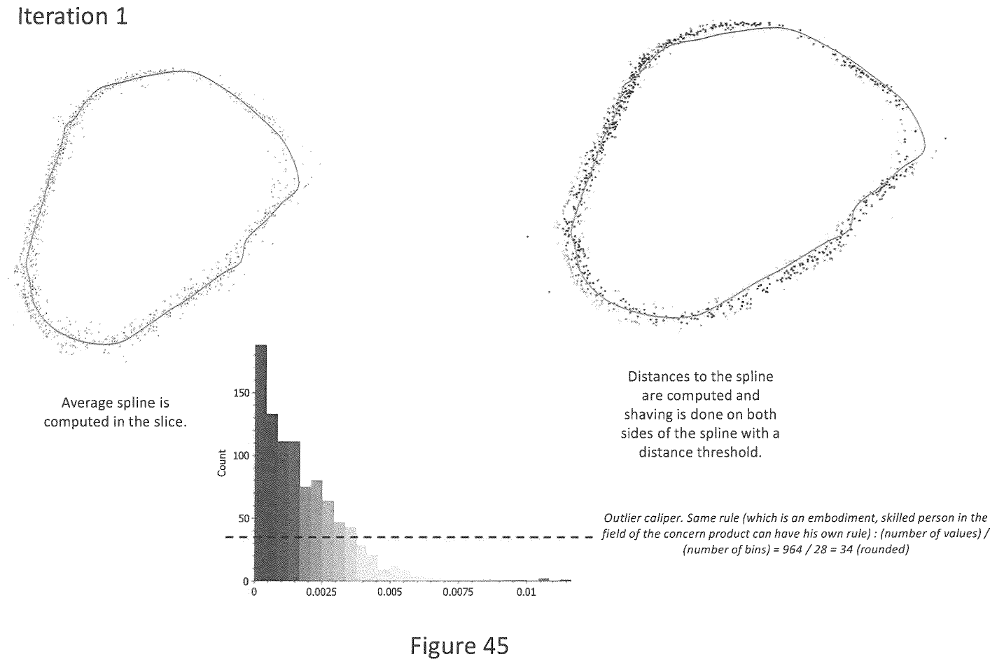

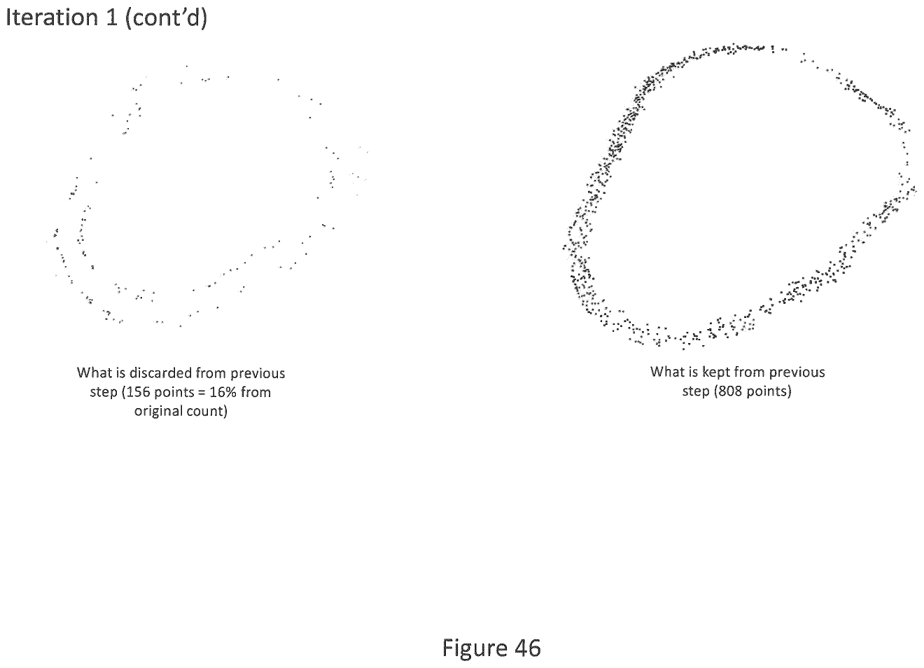

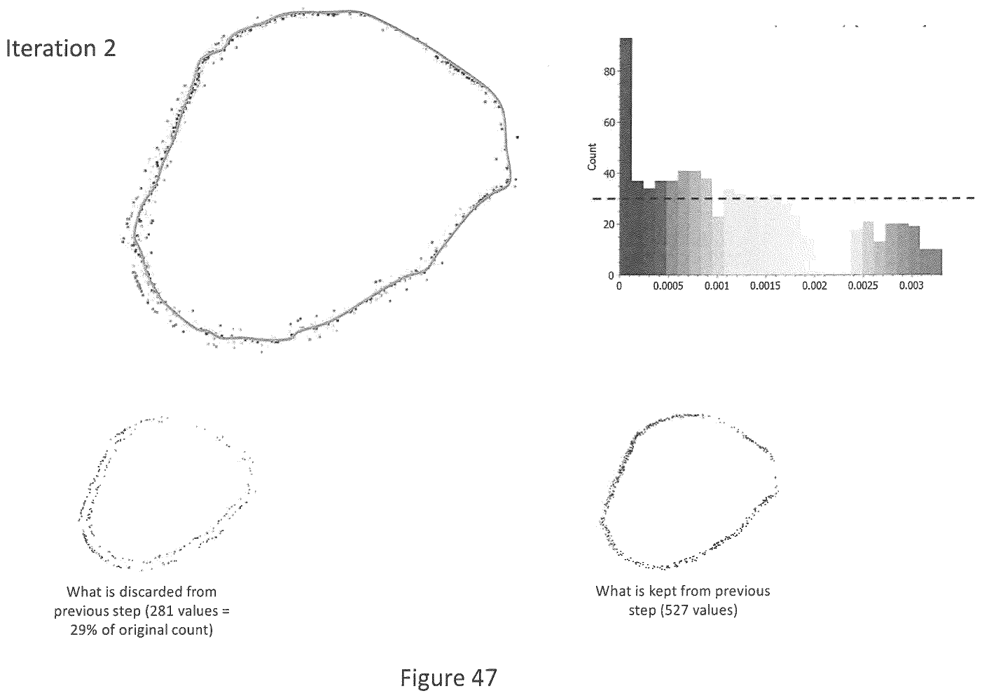

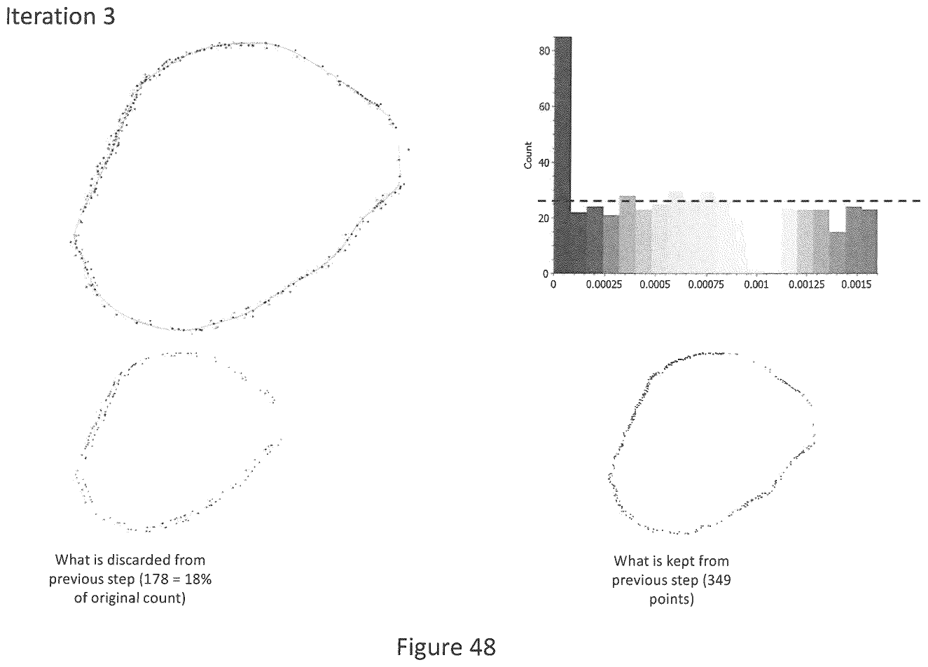

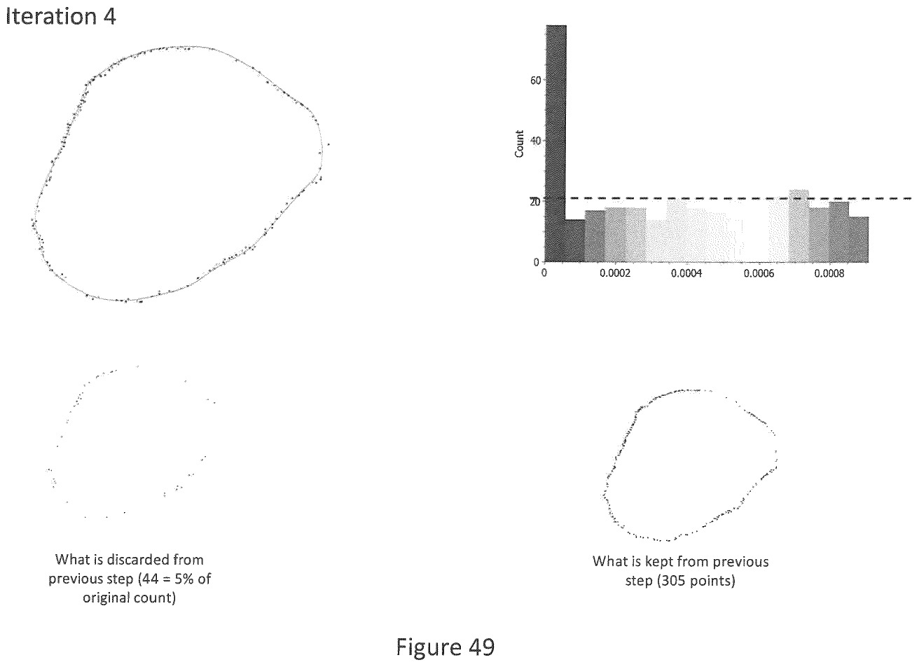

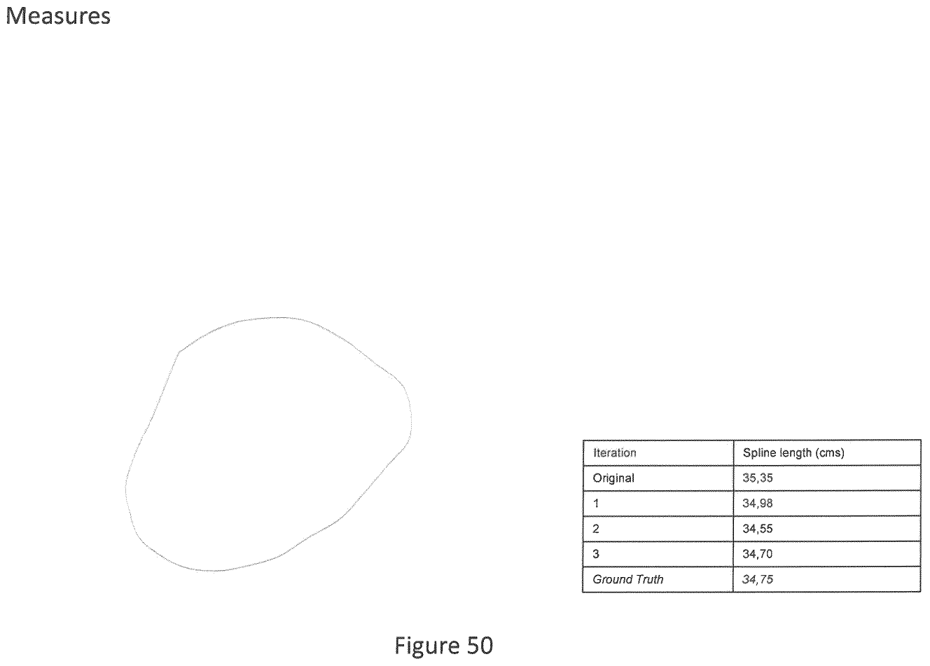

As a last example of the application of the method, FIGS. 43 to 50 describe a way to obtain a measure of the circumference of the calf of a person whose 3D reconstruction is shown on FIG. 43. The area of interest to measure is extracted under the form of a 3D slice as shown on FIG. 44. The 3D reference is an average 3D spline fitted to the 3D point cloud by regression methods well known by the skilled person. The distribution of distances of the 3D data points of the 3D point cloud to the 3D spline is not signed in this case and the removal approach is made based on a threshold of distances calculated by the statistical approach of the outlier caliper. The stopping criteria can be defined according to several criteria already explained such as i) a number of points removed at one iteration being below a percentage of the original number of points (10% in this example); ii) a number of points remaining at one iteration being below a percentage of the original number of points (35% in this example); iii) a ratio of the maximum distance of 3D data points at current iteration over the total measure of the 3D spline at the current iteration (0.3% in this example). The desired measure is the length of the 3D spline at the final iteration as shown on FIG. 50.

Although the systems and methods described herein have been described in terms of using a polynomial surface as a reference surface, it should be understood that the reference surface may be any kind of parametric surface. The example of polynomial surface was given to describe the process of iteration of the degree of the said polynomial surface at operation 130 of the method 100, but the method can be applied to the iterations of various parameters of various parametric surfaces known by the skilled person.

Parametric surfaces can be Super Quadrics, which are defined by the following equation

$${ABS ( \frac{x}{a} )}^{r} + {ABS ( \frac{y}{b} )}^{s} + {ABS ( \frac{z}{c} )}^{t} = 1 ,$$

described by 6 parameters or Super Surfaces, such as super ellipsoids defined by the following equation

$$Z = \sqrt{{[ b \cdot {( 1 - {\vert \frac{y}{a} \vert}^{\frac{2}{{ε}_{a}}} )}^{\frac{{ε}_{b}}{2}} + R ]}^{2} - {x}^{2}} ,$$

described by 5 parameters.

Finding the best fitted parametric surface at each iteration as described in the present invention is done by finding the parameters that minimize the distance to the point cloud to which the parametric surface should be fitted to. The distance between two 3D objects such as a 3D point cloud of interest and a 3D reference surface as presented in this invention are well known by the skilled person as Cloud-To-Cloud (C2C) or Cloud-To Mesh (C2M) distances. They are according to the state of the art represented as the distribution of the distances from any 3D point of one of the two surfaces that is considered as the source to the other surface that is considered as the target. From this distribution, it is possible to calculate the maximal distance, the average distance, the median distance, the distance at half height of the maximum distance or any other distance as known by the skilled person including the use of the distribution's standard deviation. The parameters of the parametric surface can be iteratively adjusted to minimize the distance between the two 3D objects and iterations 130 will stop when a minimum threshold is reached.

In some embodiments, this threshold can be determined by the skilled person as a percentage of the original measure of a part on which a weariness analysis is performed (e.g. 75% of the original height of the teeth of a gear) or a percentage of the acceptable tolerance for a welding quality (e.g. 200% of the acceptable tolerance of a welding).

In some other embodiments, the threshold at operation 130 may be inferred from the threshold at operation 170. In this case, it is considered that the current iteration of the parameters of a reference 3D parametric surface has no added value on the previous iteration and the current iteration can stop. The threshold at operation 130 can be considered from the distance (C2C or C2M) of those two consecutively iterated surfaces as a percentage of the maximum dimension of the original object (e.g. 0.5% of the original dimension). The threshold at operation 130 can also be related to the number of points that would be removed from the remaining point cloud from an iteration to the next one and if this number is too low (i.e. 0.1% of the original number of points, or 1% of the remaining points), there is no added value in the iteration of the parameters of a reference 3D parametric surface and the iteration stops.

Determining the best parameters for the 3D reference parametric surface to be fitted to the 3D reconstruction of a 3D object of interest may be based on regression analysis such as linear and/or non linear regression models such as the Generalized Reduce Gradient method, linear and/or non linear least square parameter estimation, root-finding algorithms such as bracketing methods, interpolation, iterative methods, roots of polynomial or any combination of those methods.

In some applications of the method, 3D data points are not removed but considered as different portions of the object of interest. These different portions may be treated as the remaining portion with their own 3D reference surface. At the end of the iterations, two or more reference surfaces can be positioned and used for subsequent analysis.

While the above-described implementations have been described and shown with reference to particular steps performed in a particular order, it will be understood that these steps may be combined, sub-divided, or re-ordered without departing from the teachings of the present technology. At least some of the steps may be executed in parallel or in series. Accordingly, the order and grouping of the steps is not a limitation of the present technology.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

The methods and systems described herein may be applied to various objects or items, such as rail tracks, body parts, welded surfaces, and/or any other object or item. The use of the systems and/or methods as described herein on vehicle tires and vehicle tracks is disclaimed. Except for vehicle tires and vehicle tracks, the methods and/or systems described herein may be applied to any other object or item.

What is claimed is:

1. A method for analyzing a body part, wherein the body part is not a vehicle tire or a vehicle track, comprising:
obtaining a three-dimensional (3D) point cloud of the body part;
determining, based on the 3D point cloud, a first parametric surface corresponding to a surface of the body part;
determining a first measure of signed distance between the first parametric surface and the surface of the body part in the 3D point cloud;
after determining that the first measure of signed distance fails to satisfy a threshold measure of distance, removing, from the 3D point cloud, data points that are greater than a predetermined distance from the first parametric surface;
determining, based on the 3D point cloud after removing the data points greater than the predetermined distance from the first parametric surface, a second parametric surface corresponding to the surface of the body part
determining a second measure of signed distance between the second parametric surface and the surface of the body part in the 3D point cloud; and
after determining that the second measure of signed distance satisfies the threshold measure of distance, positioning the second parametric surface on the surface of the body part defined in the initial 3D point cloud to form a final 3D point cloud.

2. The method of claim 1, further comprising determining, based on the second parametric surface, a measurement of the body part.

3. The method of claim 1, wherein the iterations of parametric surfaces continues above two until the measure of signed distances satisfies the threshold measure of distance after removing the data points greater than the predetermined distance from the current parametric surface.

4. The method of claim 1, wherein the final iterated parametric surface is positioned on an intermediate state obtained during iterations of the object of interest instead of on the initial state.

5. The method of claim 1, wherein the parametric surface is a polynomial surface of degree D, D being defined to minimize the distance between the current polynomial surface and the current 3D point cloud.

6. The method of claim 1, wherein the parametric surface is a spline that is determined by minimizing the distance between the current spline and the current 3D point cloud.

7. A method for analyzing a multidimensional surface, comprising:
obtaining a three-dimensional (3D) point cloud of an object of interest, wherein the object of interest is not a vehicle tire or a vehicle track;
determining, based on the 3D point cloud, a first parametric surface corresponding to a surface of the object of interest;
determining a first measure of signed distance between the first parametric surface and the surface of the object of interest in the 3D point cloud;
after determining that the first measure of signed distance fails to satisfy a threshold measure of distance, removing, from the 3D point cloud, data points that are greater than a predetermined distance from the first parametric surface;
determining, based on the 3D point cloud after removing the data points greater than the predetermined distance from the first parametric surface, a second parametric surface corresponding to the surface of the object of interest;
determining a second measure of signed distance between the second parametric surface and the surface of the object of interest in the 3D point cloud; and
after determining that the second measure of signed distance satisfies the threshold measure of distance, positioning the second parametric surface on the surface of the object of interest defined in the 3D point cloud to form a final 3D point cloud.

8. The method of claim 7, further comprising determining, based on the second parametric surface, a measure of wear of the object of interest.

9. The method of claim 7, further comprising determining, based on the second parametric surface, a measure of irregularity of the object of interest.

10. The method of claim 7, further comprising performing subsequent analysis on the second parametric surface.

11. The method of claim 7, wherein the iterations of parametric surfaces continues above two until the measure of signed distances satisfies the threshold measure of distance after removing the data points greater than the predetermined distance from the current parametric surface.

12. The method of claim 7, wherein the final iterated parametric surface is positioned on an intermediate state obtained during iterations of the object of interest instead of on the initial state.

13. The method of claim 7, wherein the parametric surface is a polynomial surface of degree D, D being defined to minimize the distance between the current polynomial surface and the current 3D point cloud.

14. The method of claim 7, wherein the parametric surface is a spline that is determined by minimizing the distance between the current spline and the current 3D point cloud.

15. A method for analyzing a multidimensional surface, comprising:
a) obtaining a three-dimensional (3D) point cloud of an object of interest, wherein the object of interest is not a vehicle tire or a vehicle track;
b) initializing a value D for a degree of a polynomial surface to be calculated;
c) calculating a D-degree polynomial surface of the object of interest, the D-degree polynomial surface being calculated for a surface of the object of interest defined in the 3D point cloud;
d) determining a sufficiency of the D-degree polynomial surface by evaluating a signed distance between the D-degree polynomial surface and the surface of the object of interest defined in the 3D point cloud;
e) in response to the D-degree polynomial surface being determined not to be sufficient, selectively increasing the degree D and returning to c);
f) in response to the D-degree polynomial surface being determined to be sufficient:
g) selectively positioning the D-degree polynomial surface on the surface of the object of interest defined in the 3D point cloud to form a final 3D point cloud.

16. The method of claim 15, wherein the degree D is initialized to 1 in operation b).

17. The method of claim 15, wherein, in d), evaluating the signed distance between the D-degree polynomial surface and the surface of the object of interest defined in the 3D point cloud comprises comparing the distance to a predetermined threshold.

18. The method of claim 15, further comprising counting a number of occurrences of operation c) and continuing at operation g) regardless of the sufficiency of the D-degree polynomial surface if the number of occurrences of operation c) meets or exceeds a predetermined threshold.

19. The method of claim 15, further comprising, after g) evaluating a compliance of the final 3D point cloud to a specification for the object of interest.

20. A system for analyzing a multidimensional surface, comprising:
a camera configured to provide a three-dimensional (3D) point cloud of a body part, wherein the body part is not a vehicle tire or a vehicle track;
a computer operatively connected to the camera; and
a non-transitory computer-readable medium storing computer-readable instructions that, upon being executed by the computer, cause the system to perform the method of:
obtaining the three-dimensional (3D) point cloud of the body part;
determining, based on the 3D point cloud, a first parametric surface corresponding to a surface of the body part;
determining a first measure of signed distance between the first parametric surface and the surface of the body part in the 3D point cloud;
after determining that the first measure of signed distance fails to satisfy a threshold measure of distance, removing, from the 3D point cloud, data points that are greater than a predetermined distance from the first parametric surface;
determining, based on the 3D point cloud after removing the data points greater than the predetermined distance from the first parametric surface, a second parametric surface corresponding to the surface of the body part
determining a second measure of signed distance between the second parametric surface and the surface of the body part in the 3D point cloud; and
after determining that the second measure of signed distance satisfies the threshold measure of distance, positioning the second parametric surface on the surface of the body part defined in the initial 3D point cloud to form a final 3D point cloud.
